(19) United States
(12) Patent Application Publication
(10) Pub. No.: US 2005/0160461 A1
(43) Pub. Date: Jul. 21, 2005

(54) Interactive television program guide systems with digital video recording support

(75) Inventors: Joseph P. Baumgartner, Tulsa, OK (US); Michael D. Ellis, Boulder, CO (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: UNITED VIDEO PROPERTIES, INC., Tulsa, OK (US)

(21) Appl. No.: 10/762,812

(22) Filed: Jan. 21, 2004

(51) Int. Cl. H04N 5/445; G06F 13/00; G06F 3/00; H04N 7/16

(52) U.S. Cl. 725/52; 725/53; 725/37; 725/42

(57) ABSTRACT

An interactive television system is provided in which a program listings grid is displayed for the user. The user can scroll in the backwards direction to view information on programs that have been recorded and certain video-on-demand content. Icons or other visual indicators may be provided on program listings screens to indicate the status of the programs. The status information may include an indication of whether programs are available for recording, have been recorded, are being recorded, or will be recorded, or whether a given program is available for advance viewing through the interactive television system's video-on-demand service. Programs can be recorded automatically on user equipment or on network-based equipment. A program may be automatically recorded when a user sets a reminder for the program but fails to watch the program or when a given program is determined to satisfy the user's television viewing preferences.

### BACKGROUND OF THE INVENTION

This invention relates to television systems, and more particularly, to interactive television systems with video-on-demand and video recorder capabilities.

Interactive television systems are known to provide interactive television program guide applications. An interactive television program guide application may be configured to provide a number of interactive features such as television program listings, pay-per-view and video-on-demand services, web browsing services, games, home shopping, and other interactive features, to the user.

In a typical interactive television system, the interactive television program guide application is implemented on a set-top box. The user interacts with the interactive television program guide application, for example, to access video-on-demand programming and associated content, using a remote control.

In a computer environment, the user accesses an online interactive television program guide application to obtain desired information such as information associated with video-on-demand programming.

Personal video recorders (PVRs) generally include a hard disk drive for storing digital video recordings that may be played back on a user's television equipment. Video recorder functionality may also be provided using network-based equipment. A user may direct a PVR or a network-based video recorder using an interactive television program guide application implemented on the user's local equipment. However, it is difficult to organize the programs that have been recorded on PVRs and network recorders such that a user can easily locate a recorded program. It is also difficult for a user to determine the status of the recorder, such as which programs, for example, are available for recording, are scheduled for recording, have been recorded, are currently being recording, or other similar status information.

It would therefore be desirable to be able to clearly present status information regarding video-on-demand programs and recorded programs to a user. Furthermore, because such information may assist the user in making decisions about their viewing schedule and what programs to watch, it would also be desirable to provide this information to the user in a clear and organized context.

### SUMMARY OF THE INVENTION

In accordance with the present invention, interactive television systems, such as interactive television program guide systems, are provided that provide users with information related to the recording of television programs and video-on-demand programs thereby helping users with accessing and managing such content. Programs may be recorded using local personal video recorders or network-based video recorders, both of which may be part of the present system.

An interactive television program guide application of the present invention may be used to provide a program guide interface screen with information on scheduled television programs. The interactive television program guide application may also be used to provide the user with information on video-on-demand programs and recorded programs. The interactive television application may be implemented at least partially on user equipment, such as a set-top box. The interactive television application may also be implemented on network-based equipment.

The interactive television program guide application may display the foregoing program information to the user in the form of a program listings grid, in which each cell of the grid may contain a program title and any other suitable information. Such grids may be organized by, for example, the start time and the channel of each listed program. Program listings information may also be displayed by the interactive television program guide application in, for example, a grid format, a list format, a menu format, or other suitable formats. The application may also display categories or classifications of programs.

The interactive television program guide application may allow the user to select a program listed in the display screen and direct the application to take an action with respect to the selected program. For example, the user may direct the application to display the selected program for viewing, to schedule a reminder or recording for the selected program, to provide additional information about the selected program, or any other suitable action.

Programs listed in the displayed program guide interface screen may also be associated with visual indicators that provide additional information about the program to the user. For example, visual indicators may be used to indicate to the user that the associated program is available for recording, has been recorded, is currently being recorded, is scheduled for recording, is scheduled for a reminder, or any other suitable information or combination thereof.

The interactive television program guide application may allow the user to scroll the displayed program listings grid backwards in time. When the user scrolls the program listings grid in this manner, the program listings grid may display information relating to previously broadcast programs, particularly if these programs are still available for viewing by the user. For example, by scrolling the program listings backwards, the interactive television program guide application may display a previously broadcast program title that has been recorded and is therefore available for viewing by the user. The program listings grid may also display video-on-demand programs that are still available for viewing by the user. Other previously broadcast programs that are no longer available for viewing because, for example, the program was not recorded may instead be replaced with an empty cell, thereby indicating to the user that it is no longer available for viewing. Programs may also become unavailable for viewing after a limited period of time, such as video-on-demand programs or recorded programs stored for a limited time. The application may allow the user to request an extension of the time of availability. Such a request may exact a fee from the user.

The user may direct the interactive television program guide application to record or to schedule for recording a television program or other video programming. For example, the interactive television application may be used to facilitate the recording of a television program using a local personal video recorder of the user equipment. The interactive television application may also be used to facilitate the recording of a television program on a network-based video recorder implemented on equipment that is separate from the user's equipment. A network-based video recorder may be located at, for example, a server located at a cable system headend, a network node, or any other suitable remote location that is in communication with the user's equipment. In a network-based video recorder, a given user may be allocated a personal storage area for their recordings. The network-video recorder may also store recorded programs that are available to more than one user. Programs may also be recorded by the local or network video recorder when, for example, the user directs the interactive television program guide application to record the program, when the user sets a reminder for a program but fails to watch that program, when a program matches the user's preferences, or by any other suitable criteria. Under suitable circumstances, programs may be automatically recorded by the interactive television program guide application.

The interactive television program guide application may determine a personal profile for a user based on information gathered about the user. The personal profile may be used by the application to determine which programs are to be selected for, for example, automatic recording, availability for recording and viewing by the user, or other suitable uses.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive television system in accordance with various embodiments of the present invention.

FIG. 2 is a diagram of illustrative user television equipment in accordance with various embodiments of the present invention.

FIG. 3 is a diagram of additional illustrative user television equipment in accordance with various embodiments of the present invention.

FIG. 4 is a diagram of an illustrative remote control in accordance with various embodiments of the present invention.

FIG. 5 is a diagram of illustrative user computer equipment in accordance with various embodiments of the present invention.

FIG. 6 is a generalized diagram of illustrative user equipment in accordance with various embodiments of the present invention.

FIG. 7 shows an illustrative menu screen in accordance with various embodiments of the present invention.

FIG. 8 shows an illustrative program guide screen in accordance with various embodiments of the present invention.

FIG. 9 is an illustrative display screen showing how a flip banner that contains program listings information for the current channel may be displayed as an overlay over video of the current channel in accordance with various embodiments of the present invention.

FIG. 10 is an illustrative display screen showing how a browse banner that contains program listings information for a channel that may differ from the current channel may be displayed as an overlay over video of the current channel in accordance with various embodiments of the present invention.

FIG. 11 shows an illustrative program guide screen in accordance with various embodiments of the present invention.

FIG. 12 is an illustrative display screen showing how an interactive television application may provide a user with an opportunity to set a program reminder in accordance with various embodiments of the present invention.

FIG. 13 is an illustrative display screen showing how a reminder may be provided for a user in accordance with various embodiments of the present invention.

FIG. 14 is a display screen showing an illustrative video-on-demand menu that may be used to select a category of video-on-demand content in accordance with various embodiments of the present invention.

FIG. 15 is a display screen showing an illustrative video-on-demand menu screen that may be used to locate a desired type of movie in accordance with various embodiments of the present invention.

FIG. 16 shows an illustrative title menu that may be used to select a video-on-demand title of interest in accordance with the present invention.

FIGS. 17a and 17b are illustrative video-on-demand information screens that may be used to access video-on-demand content in accordance with various embodiments of the present invention.

FIG. 18 is an illustrative display screen showing how video-on-demand playback controls may be displayed while video-on-demand content is being displayed for the user in accordance with various embodiments of the present invention.

FIGS. 19a and 19b are illustrative display screens showing how a user's scheduled recordings may be presented and selected in an interactive list in accordance with various embodiments of the present invention.

FIGS. 20a and 20b are illustrative display screens showing how a user's recordings may be presented and selected from an interactive list in accordance with various embodiments of the present invention.

FIG. 21 is an illustrative display screen showing how video for a recording selected from the list of FIG. 18 may be displayed for the user in accordance with various embodiments of the present invention.

FIG. 22 is an illustrative display screen showing how the user may be provided with options that allow the user to schedule a recording of a desired program in accordance with various embodiments of the present invention.

FIG. 23a is an illustrative display screen showing how a user may set parental controls for a given program in accordance with various embodiments of the present invention.

FIG. 23b is an illustrative display screen showing how a user may block content by creating a time-based parental control setting in accordance with various embodiments of the present invention.

FIG. 24 is an illustrative display screen showing how icons or other indicators may be displayed adjacent to program listings to indicate their status in accordance with various embodiments of the present invention.

FIG. 25 is an illustrative display screen showing how a grid of program listings of the type shown in FIG. 24 can be scrolled backwards to times before the present time in accordance with various embodiments of the present invention.

FIG. 26 is an illustrative display screen showing how the grid of FIG. 25 may appear after additional backwards scrolling in accordance with various embodiments of the present invention.

FIG. 27 is an illustrative display screen showing how a list of program listings may be provided after the user scrolls in the backwards direction before the current time in accordance with various embodiments of the present invention.

FIG. 28 is an illustrative display screen showing a menu of recording-related options that may be presented when the user scrolls a program listings grid in the backwards direction in accordance with various embodiments of the present invention.

FIG. 29 is a display screen that may be provided to the user when the user selects an alphabetical listings option from a program guide screen such as the program guide screen of FIG. 28 in accordance with various embodiments of the present invention.

FIG. 30 is a flow chart of illustrative steps involved in making automatic recordings in accordance with various embodiments of the present invention.

### DETAILED DESCRIPTION OF THE PREFERRED EMBODIMENTS

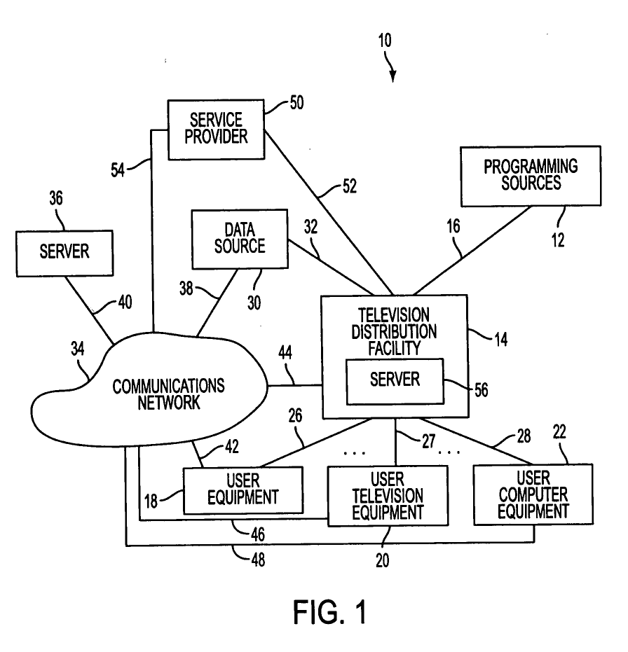

An illustrative interactive television system 10 in accordance with the present invention is shown in FIG. 1. Content such as television programming and other media, such as digital music, may be provided from programming sources 12 to television distribution facilities such as television distribution facility 14 using communications path 16. Programming sources 12 may be any suitable sources of television and music programming, such as television and music production studios, etc.

Television distribution facility 14 may be a cable system headend, a satellite television distribution facility, a television broadcast facility, or any other suitable facility for distributing television and music programming to users. There are typically numerous television distribution facilities 14 in system 10, but only one is shown in FIG. 1 to avoid overcomplicating the drawings.

Communications path 16 may be a satellite path, a fiber-optic path, a cable path, or any other suitable wired or wireless communications paths or a combination of such paths.

Television distribution facility 14 may be connected to various user equipment devices 18. Such user equipment 18 may, for example, be located in the homes of users. User equipment 18 may include user television equipment 20 or user computer equipment 22.

The user equipment may receive television and music programming and other information from television distribution facility 14 over communications paths such as communications paths 26, 27, and 28. The user equipment may also transmit signals to television distribution facility 14 over paths 26, 27, and 28. Paths 26, 27, and 28 may be cables or other wired connections, or wireless connections for broadcast or satellite links.

Data source 30 may include a program listings database that is used to provide the user equipment with information for the interactive television program guide, such as scheduled broadcast times, titles, channels, ratings information (e.g., parental ratings and critic's ratings), detailed title descriptions, genre or category information (e.g., sports, news, movies, etc.), information on actors and actresses, running times, etc. Data source 30 may also be used to provide advertisements (e.g., program guide advertisements and advertisements for other interactive television applications), real-time data such as sports scores, stock quotes, news, weather, etc. Although data source 30 is drawn as an individual box in FIG. 1, data source 30 and the other system components of FIG. 1 may be provided using equipment at one or more locations. Systems components are drawn as single boxes in FIG. 1 to avoid over-complicating the drawings.

Data source 30 may provide program schedule information and other data to television distribution facility 14 over communications path 32 for distribution to the associated user equipment over paths 26, 27, and 28. Communications path 32 may be any suitable communications path such as a satellite communications path or other wireless path, a fiber-optic or other wired communications path, a path that supports Internet communications, a combination of such paths, etc. Data source 30 may provide program schedule information and other data to the user at user equipment 18 over path 38, communications network 34, and path 42. Path 42 may be a wired path such as a telephone line, a cable path, a fiber-optic path, a satellite path, a wireless path, a combination of such paths, or any other suitable path.

User equipment devices such as user television equipment and personal computers may use the program schedule information to display program listings and information on digital music for the user. An interactive television program guide application or other suitable application may be used to display such information on the user's display.

An on-line program guide and other interactive television services may be provided using a server connected to communications network 34 such as server 36. Server 36 may receive program schedule information and other data from data source 30 via communications path 38, communications network 34, and communications path 40. Paths 38 and 40 may be satellite paths, fiber-optic paths, wired paths, etc. Communications network 34 may be any suitable communications network, such as the Internet, the public switched telephone network, a packet-based network, etc.

User equipment 18 may access on-line program-guide information and other information from server 36 via communications path 42. User equipment 18 may also access the on-line program guide and other services on server 36 via communications path 26, television distribution facility 14, and communications path 44. For example, a cable modem or other suitable equipment may be used by user equipment 18 to communicate with television distribution facility 14. Television distribution facility 14 may communicate with communications network 34 over any suitable path 44, such as a wired path, a cable path, a fiber-optic path, a satellite path, a wireless path, a combination of such paths, etc.

User equipment such as user television equipment 20 and user computer equipment 22 may access the on-line program guide and server 36 using similar arrangements. User television equipment 20 may access the on-line program guide and server 36 using communications path 46 or using path 27, television distribution facility 14, and path 44. User computer equipment 22 may access the on-line program guide and server 36 using communications path 48 or using path 28, television distribution facility 14, and path 44. Paths 46 and 48 may be any suitable paths, such as wired paths, cable paths, fiber-optic paths, satellite paths, wireless paths, a combination of such paths, etc.

Program guide application functions and the functions of other interactive television applications may be supported using server 36 and other servers connected to communications network 34 such as server 56. Interactive television applications may also be supported by servers or other suitable equipment at one or more service providers such as service provider 50. For example, a home shopping service may be supported by a service provider such as service provider 50 that has sales representatives, order fulfillment facilities, account maintenance facilities, and other equipment for supporting interactive home shopping features. A home shopping application that is implemented using the user equipment may be used to access the service provider to provide these features to the user. The user equipment may access service provider 50 via television distribution facility 14 and communications path 52 or via communications network 34 and communications path 54. Communications paths such as paths 52 and 54 may be any suitable paths, such as wired paths, cable paths, fiber-optic paths, satellite paths, wireless paths, a combination of such paths, etc.

Another example of an interactive television application is a home banking application. A home banking service may be supported using personnel at facilities such as service provider 50. An interactive home banking application that is implemented using the user equipment may access the home banking service via television distribution facility 14 and communications path 52 or via communications network 34 and communications path 54.

If desired, an interactive television application such as a network-based video recorder or a video-on-demand application may be supported using server 56, server 36, or equipment at service provider 50. Video-on-demand content and video recorded using a network-based video recorder arrangement may be stored on server 56 or server 36 or at service provider 50 and may be provided to the user equipment when requested by users. An interactive television application may be used to support the functions of a personal video recorder (sometimes called a digital video recorder) that is implemented using user equipment 18. Illustrative equipment that may be used to support personal video recorder functions include specialized personal video recorder devices, integrated receiver decoders (IRDs), set-top boxes with integrated or external hard drives, or personal computers with video recording capabilities.

If desired, applications such as the interactive television program guide application, a home shopping application, a home banking application, a video-on-demand application, game applications, and other applications (e.g., applications related to e-mail and chat or other communications functions, etc.) may be provided as separate applications that are accessed through a navigation shell application (i.e., a menu application with menu options corresponding to the applications). The features of such applications may be combined. For example, games, vide-on-demand services, home shopping, network-based video recorder functions, personal video recorder functions, navigational functions, program guide functions, communications functions, and other suitable functions may be provided using one application or any other suitable number of applications.

Moreover, the interactive television program guide application, the home banking application, the home shopping application, the network-based video recorder and personal video recorder applications, the video-on-demand application, the gaming applications, communications applications, and navigational applications, are only a few illustrative examples of the types of interactive television applications that may be supported by system 10. Other suitable applications that may be supported include, news services, web browsing and other Internet services, and interactive wagering services (e.g., for wagering on horse races and the like).

The interactive television application or applications that are used in interactive television system 10 may be implemented locally on the user equipment. The applications may also be implemented in a distributed fashion (e.g., using a client-server architecture in which the user equipment serves at least partly and for at least some of the time, as the client and a server such as server 56 at television distribution facility 14, server 36, or other suitable equipment acts as the server. Other distributed architectures may also be used if desired. Moreover, some or all of the interactive television system features of system 10 may be provided using operating system software or middleware software. Such operating system software and middleware may be used instead of or in combination with application-level software. Regardless of the particular arrangement used to implement interactive television features related to program guides, home shopping, home banking, video-on-demand, Internet, communications, etc., the software that supports these features may be referred to as an application or applications.

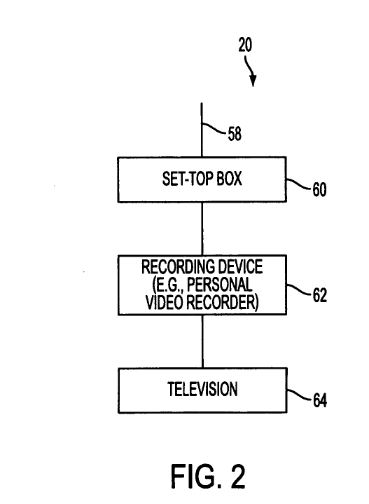

Illustrative user television equipment 20 that is based on a set-top box arrangement is shown in FIG. 2. Input/output 58 may be connected to communications paths such as paths 27 and 46. Input/output functions may be provided by one or more wires or communications paths, but are shown as a single path in FIG. 2 to avoid overcomplicating the drawing. Television programming and other information may be received using input/output 58. Commands and requests and other information from the user may also be transmitted over input/output 58.

Set-top box 60 may be any suitable analog or digital set-top box (e.g., a cable set-top box). Set-top box 60 may contain an analog tuner for tuning to a desired analog television channel. Set-top box 60 may also contain digital decoding circuitry for receiving digital television and music channels. Both analog and digital channels may be handled together if desired. Multiple tuners may be provided (e.g., to handle simultaneous watch and record functions). Set-top box 60 may be an integrated receiver decoder (IRD) that handles satellite television. If desired, set-top box 60 may have circuitry for handling cable, over-the-air broadcast, and satellite content. Set-top box 60 may include a storage device (e.g., a digital storage device such as a hard disk drive) for providing recording capabilities. Set-top box 60 may also be connected to a recording device 62 such as a video cassette recorder, personal video recorder, or other device or devices with storage capabilities.

Set-top box 60 contains a processor (e.g., a microcontroller or microprocessor or the like) that is used to execute software applications. Set-top box 60 may contain memory such as random-access memory for use when executing applications. Nonvolatile memory may also be used (e.g., to launch a boot-up routine and other instructions). Hard disk storage in set-top box 60 or in recording device 62 may be used to back up data and to otherwise support larger databases and storage requirements than may be supported using random-access memory approaches.

Set-top box 60 may have infrared (IR) or other communications circuitry for communicating with a remote control or wireless keyboard. Set-top box 60 may also have dedicated buttons and a front-panel display. The front-panel display may, for example, be used to display the current channel to which the set-top box is tuned.

Set-top box 60 may also have communications circuitry such as a cable modem, an integrated services digital network (ISDN) modem, a digital subscriber line (DSL) modem, a wireless modem, a telephone modem, etc. for communications with other equipment. Such communications may involve the Internet or any other suitable communications networks or paths. If desired, the components of set-top box 60 may be integrated into other user equipment (e.g., a television or videocassette recorder).

Recording device 62 may be used to record videos provided by set-top box 60. For example, if set-top box 60 is tuned to a given television channel, the video signal for that television channel may be passed to recording device 62 for recording on a videocassette, compact disc, digital video disk, or internal hard drive or other storage device. Recording device 62 may have communications circuitry such as a cable modem, an ISDN modem, a DSL modem, a telephone modem, etc. for communications with other equipment. Such communications may involve the Internet or any other suitable communications networks or paths. The components of recording device 62 may be integrated into other user equipment (e.g., a television, stereo equipment, etc.).

Recording device 62 may be controlled using a remote control or other suitable user interface. If desired, video recorder functions such as start, stop, record, etc. and other functions for device 62 may be controlled by set-top box 60. For example, set-top box 60 may control recording device 62 using infrared commands directed toward the remote control inputs of recording device 62 or set-top box 60 may control recording device 62 using other wired or wireless communications paths between box 60 and device 62.

The output of recording device 62 may be provided to television 64 for display to the user. If desired, multiple recording devices 62 or no recording device 62 may be used. If recording device 62 is not present or is not being actively used, the video signals from set-top box 60 may be provided directly to television 64. Any suitable television or monitor may be used to display the video. In the equipment of FIG. 2 and the other equipment of system 10, the audio associated with various video items is typically distributed with those video items and is generally played back to the user as the videos are played.

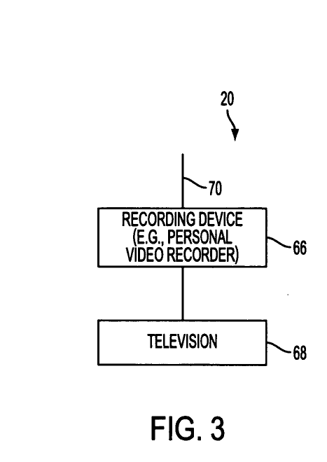

Another illustrative arrangement for user television equipment 20 is shown in FIG. 3. In the example of FIG. 3, user television equipment 20 includes a recording device 66 such as a digital video recorder (e.g., a personal video recorder (PVR)) that uses a hard disk or other storage for recording video or may be a digital video disc recorder, compact disc recorder, videocassette recorder, or other suitable recording device. Equipment 20 of FIG. 3 may also include a television 68. Input/output 70 may be connected to communications paths such as paths 27 and 46. Television programming and other information may be received using input/output 70. Commands and requests and other information from the user may be transmitted over input/output 70.

Recording device 66 may contain at least one analog tuner for tuning to a desired analog television channel. Recording device 66 may also contain digital decoding circuitry for receiving digital television and music channels. If desired, recording device 66 may contain circuitry for handling both analog and digital channels. Recording device 66 also contains a processor (e.g., multiple tuners may be provided, a microcontroller or microprocessor or the like) that is used to execute software applications. Recording device 66 may contain memory such as random-access memory for use when executing applications. Nonvolatile memory may also be used to store a boot-up routine or other instructions. The hard disk and other storage in recording device 66 may be used to support databases (e.g., program guide databases or interactive television application databases). The hard disk or other storage in recording device 66 may also be used to record video such as television programs or video-on-demand content or other content provided to recording device 66 over input/output 70.

Recording device 66 may have IR communications circuitry or other suitable communications circuitry for communicating with a remote control. Recording device 66 may also have dedicated buttons and a front-panel display. The front-panel display may, for example, be used to display the current channel to which the recording device is tuned.

Recording device 66 may also have communications circuitry such as a cable modem, an ISDN modem, a DSL modem, a telephone modem, a wireless modem, etc. for communications with other equipment. Such communications may involve the Internet or other suitable communications networks or paths.

If desired, recording device 66 may include a satellite receiver or other equipment that has wireless communications circuitry for receiving satellite signals.

Recording device 66 of FIG. 3 or recording device 62 of FIG. 2 may record new video while previously recorded video is being played back on television 68 or 64. This allows users to press a pause button during normal television viewing. When the pause button is pressed, the current television program is stored on the hard disk of digital video recorder 66. When the user presses play, the recorded video may be played back. This arrangement allows the user to seamlessly pause and resume television viewing. Recording device 66 and 62 may also be used to allow a user to watch a previously-recorded program while simultaneously recording a new program.

The set-top box arrangement of FIG. 2 and the digital video recorder set-top box arrangement of FIG. 3 are merely illustrative. Other arrangements may be used if desired. For example, user television equipment may be based on a WebTV box, a personal computer television (PC/TV), or any other suitable television equipment arrangement. If desired, the functions of components such as set-top box 60, digital video recorder 66, a WebTV box, or PC/TV or the like may be integrated into a television or personal computer or other suitable device.

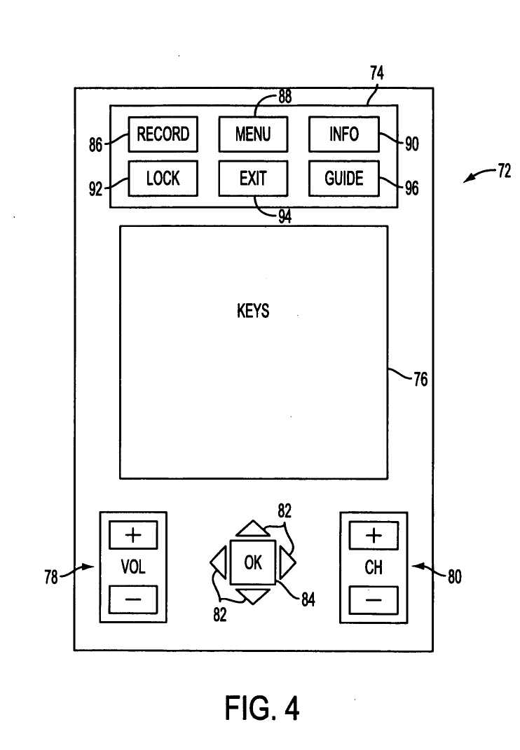

An illustrative remote control 72 for operating user television equipment 20 (or suitable user computer equipment 22) is shown in FIG. 4. Remote control 72 may have function keys 74 and other keys 76 such as keypad keys, power on/off keys, pause, stop, fast-forward and reverse keys, etc. Volume up and down keys 78 may be used for adjusting the volume of the audio portion of a video. Channel up and down keys 80 may be used to change television channels and to access content on virtual channels. Cursor keys 82 may be used to navigate on-screen menus. For example, cursor keys 82 may be used to position an on-screen cursor, indicator, or highlight (sometimes all generically referred to herein as a highlight or highlight region) to indicate interest in a particular option or other item on a screen displayed by the interactive television application.

An OK key 84 (sometimes called a select or enter key) may be used to select on-screen options that the user has highlighted.

Keys 74 may include a record key 86 for initiating recordings. Menu button 88 may be used to direct the interactive television application to display a menu on the user's display screen (e.g., on television 64 or 68 or on a suitable monitor or computer display). Info button 90 may be used to direct the interactive television application to display an information display screen. If the user has highlighted a particular program listing, for example, pressing the info button 90 may direct the interactive television application to provide additional program schedule information related to that program listing (e.g., a program summary, actor information, etc.).

Lock button 92 may be used to modify access privileges. For example, a parent may use lock button 92 or on-screen options to establish parental control settings for the interactive television application. The parental control settings may be time-based settings (e.g., to prevent a child from watching television during a particular time block such as from 3:00 PM to 5:00 PM). The parental control settings may also be used to block programming based on rating, channel, program title, etc. A locked or blocked program is typically not viewable until the interactive television application is provided with a suitable personal identification number (PIN). Once this PIN has been entered, the interactive television program will unlock the user's equipment and allow the locked content to be accessed.

Exit button 94 may be used to exit the interactive television application or to exit a portion of the interactive television application. Guide button 96 may be used to invoke the interactive television program guide.

The keys shown in FIG. 4 are merely illustrative. Other keys or buttons may be provided if desired. For example, a music button may be used to access music with the interactive television application. An edit button may be used to edit stored content (e.g., to remove commercials, remove portions of a video, etc.). Alphanumeric buttons may be used to enter alphanumeric characters. A last or back button may be used to browse backward in the interactive television application (e.g., to return to a previous channel or display screen). Video recorder function buttons such as a play button, pause button, stop button, rewind button, fast-forward button, and record button, may be used to control video recorder functions (local or network-based) in system 10. A help key may be used to invoke help functions such as context-sensitive on-screen help, etc.

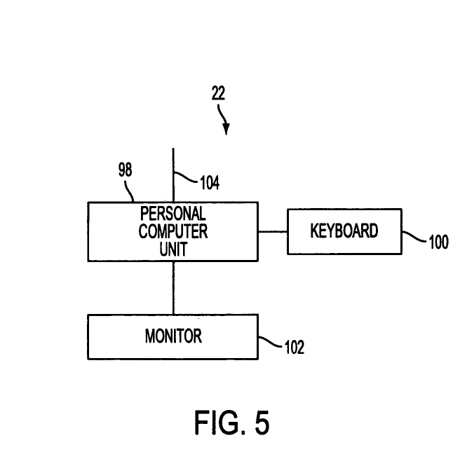

Illustrative user computer equipment 22 is shown in FIG. 5. In the arrangement of FIG. 5, personal computer unit 98 may be controlled by the user using keyboard 100 or other suitable user input device, such as a trackball, mouse, touch pad, touch screen, voice recognition system, a remote control such as remote control 72 of FIG. 4, etc. Video content such as television programming and interactive television application display screens may be displayed on monitor 102. Television programming, video-on-demand content, video recordings played back from a network-based video recorder, and other information may be received from paths 28 and 48 (FIG. 1) using input/output 104. The user may also send commands and other information used during interactions with the interactive television application and system 10 over input/output line 104.

Personal computer unit 98 may contain a television or video card such as television tuner card for decoding analog and digital television channels and for handling streaming video content. Multiple video cards (e.g., tuner cards) may be provided if desired. An illustrative television tuner card that may be used may contain an analog television tuner for tuning to a given analog channel and digital decoding circuitry for filtering out a desired digital television or music channel from a packetized digital data stream. Any suitable card or components in computer unit 98 may be used to handle video and other content delivered via input/output line 104 if desired.

Personal computer unit 98 may contain one or more processors (e.g., microprocessors) that are used to run the interactive television application or a portion of the interactive television application.

Storage in personal computer unit 98 such as a hard drive, DVD drive, CD drive, or other suitable storage device or devices may be used to store video and other content. For example, the interactive television application and personal computer unit 98 may use this storage to provide the functions of a personal video recorder.

User equipment 18 such as user television equipment 20 and user computer equipment 22 may be used with network equipment such as server 56, server 36, and equipment at service providers such as service provider 50 of FIG. 1 to provide network-based video recording functions. Video recording functions may be provided by storing copies of television programs and other video content on a remote server (e.g., server 56 or server 36 of FIG. 1) or other network-based equipment such as equipment at a service provider such as service provider 50.

Video recordings may be made in response to user commands that are entered at user equipment 18. In a personal video recorder arrangement, the interactive television application may be used to record video locally on the user equipment in response to the user commands. In a network-based video recorder arrangement, the interactive television application may be used to record video or to make virtual recordings on network equipment such as server 36, 56, or equipment at service provider 50 in response to the user commands. The user commands may be provided to the network equipment over the communications paths shown in FIG. 1. The personal video recorder arrangement and the network-based video recorder arrangement can support functions such as fast-forward, rewind, pause, play, and record.

To avoid unnecessary duplication in a network-based video recorder environment, the system 10 may provide network-based video recording capabilities by using virtual copies or recordings. With this approach, each user may be provided with a personal area on the network that contains a list of that user's recordings. The video content need only be stored once (or a relatively small number of times) on the network equipment, even though a large number of users may have that video content listed as one of their recordings in their network-based video recorder personal area.

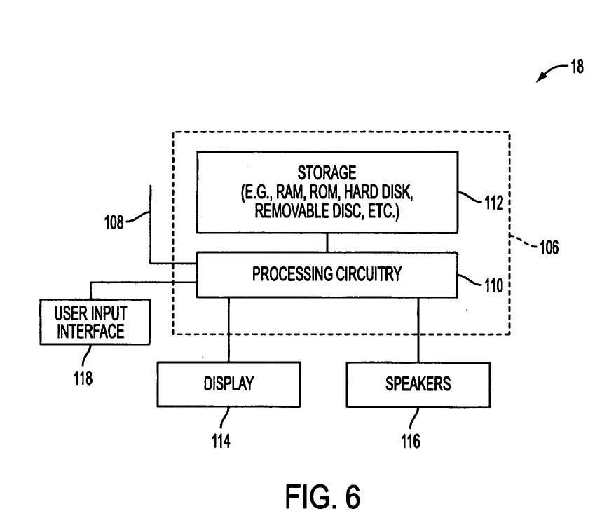

The user television equipment and user computer equipment arrangements described above are merely illustrative. A more generalized embodiment of illustrative user equipment is shown in FIG. 6.

As shown in FIG. 6, control circuitry 106 is connected to input/output 108. Input/output 108 may be connected to one or more communications paths such as paths 26, 27, 28, 42, 46, and 48 of FIG. 1. Television and music programming may be received via input/output 108 (e.g., from programming sources 12, servers or other equipment such as server 36, service providers such as service provider 50, and television distribution facility 14). Program schedule information for an interactive television program guide may be received from data source 30 via input/output 108. Input/output 108 may also be used to receive information from data source 30 for other interactive television applications. The user may use control circuitry 106 to send commands, requests, and other suitable information using input/output 108.

Control circuitry 106 may be based on any suitable processing circuitry 110 such as processing circuitry based on one or more microprocessors, microcontrollers, digital signal processors, programmable logic devices, etc. Memory (e.g., random-access memory and read-only memory), hard drives, DVD drives, CD drives, or any other suitable memory or storage devices may be provided as storage 112 that is part of control circuitry 106. Tuning circuitry such as one or more analog tuners, one or more MPEG-2 decoders or other digital video circuitry, or any other suitable tuning or video circuits or combinations of such circuits may also be included as part of circuitry 106. Encoding circuitry (e.g., for converting over-the-air or cable analog signals to MPEG signals for storage) may also be provided. The tuning and encoding circuitry may be used by the user equipment to receive and display or play or record a particular television or music channel or other desired audio and video content (e.g., video-on-demand content or requested network-based or local video recorder playback). Television programming and other video and on-screen options and information may be displayed on display 114. Display 114 may be a monitor, a television, or any other suitable equipment for displaying visual images. Speakers 116 may be provided as part of a television or may be stand-alone units. Digital music and the audio component of videos displayed on display 114 may be played through speakers 116.

A user may control the control circuitry 106 using user input interface 118. The user input interface 118 may be any suitable user interface, such as a mouse, trackball, keypad, keyboard, touch screen, touch pad, voice recognition interface, remote control, etc.

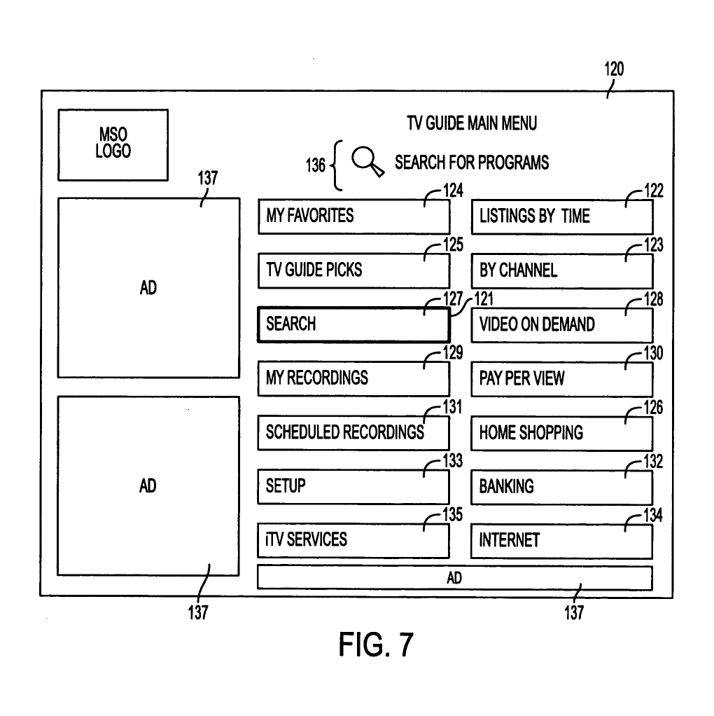

An illustrative menu 120 that may be displayed on the user's display screen is shown in FIG. 7. As shown in FIG. 7, menu 120 may provide the user with an number of selectable options. The options shown in FIG. 7 are merely illustrative. Any suitable options may be provided if desired.

A user of user equipment 18 (e.g., a user of user television equipment 20 or a user of user computer equipment 22, or a user of any other suitable user equipment device) may invoke an interactive television menu such as menu screen 120 by pressing menu button 88 (FIG. 4). Remote control 72 (FIG. 4) or other user interface 118 (FIG. 6) may be used to position highlight region 121 on top of selectable options such as options 122-135. If the user selects option 122 or 123, a screen of program listings may be displayed. Option 124 may be used to display program listings for channels designated by the user as “favorites.” Option 125 may be used to provide program listings selected for promotion by a service provider (e.g., a program guide service provider, a cable operator, etc.). Option 126 may be used to invoke a home shopping service. Options 127 may be used to search program listings by title, time, category, or any other criteria. Option 128 may be selected to display options related to video-on-demand services. Option 129 may be selected to display an interactive list of previously recorded recordings and option 131 may be selected to display an interactive list of programs scheduled for recording. Option 130 may be selected to display pay-per-view program listings and pay-per-view services options. If the user selects option 132, the user may be presented with an opportunity to access home banking functions. Option 133 may be selected to change system setup options and option 134 may be selected to launch a web browser or other application for accessing the Internet. Option 135 may be selected to access other interactive television services. When the user selects an option with highlight region 121 from menu screen 120, the user's selection may be described in information display region 136.

If desired, program guide screens such as menu screen 120 and other interactive television application screens may include selectable advertisements 137. Any suitable advertisements may be provided, including panel advertisements, banner advertisements, advertisements provided between program listings, advertisements provided on certain program listings or other portions of the screen, or any other suitable advertisements. A user may use cursor keys 82 of remote control 72 (FIG. 4) to position a highlight region on an advertisement of interest and may select the highlighted advertisement using OK key 84. Users of other user interfaces may make appropriate selections using the buttons or controls available through those interfaces (e.g., using voice commands if the user interface involves a voice recognition arrangement, etc.).

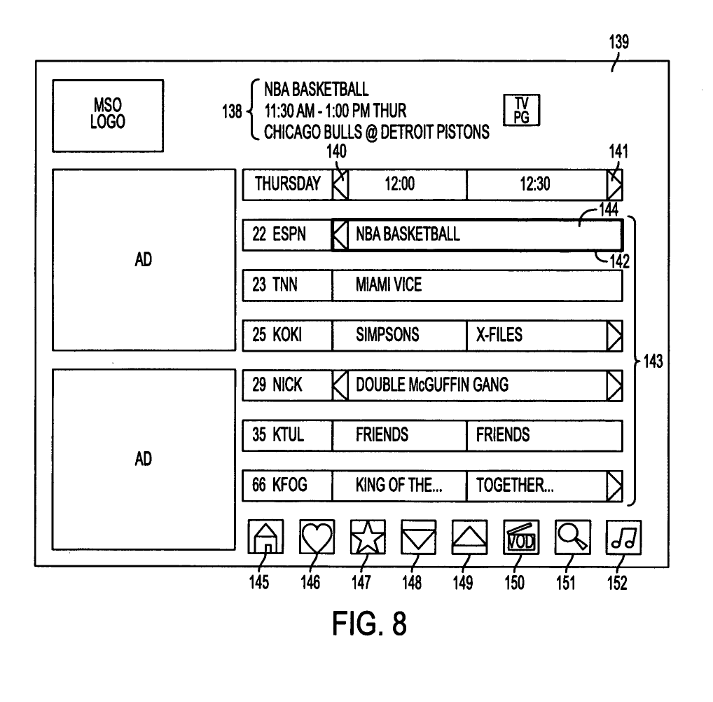

An illustrative program guide screen 138 that may be displayed for the user is shown in FIG. 8. Program guide screen 138 may be displayed, for example, when the user selects program listings option 122 of FIG. 7, when the user selects a suitable option from within an interactive television program guide application or other interactive television application, or when the user presses an appropriate remote control button such as guide button 96 or otherwise uses user input interface 118 to indicate a desire to view program listings.

Program guide screen 138 may contain a grid or list of program listings 143. Program listings 143 may include program titles, channels, scheduled broadcast times, and any other suitable program schedule information.

Highlight region 142 may be used to select a desired program listing 144. Program Information for selected programs may appear elsewhere on program guide screen 138 (e.g., in program information display region 139). If the user presses OK key 84 when a program listing for a current program is highlighted, the interactive television application may tune to the channel for that program. If the user presses OK key 84 when a program listing for a future program is highlighted, the interactive television application may provide the user with an opportunity to set a reminder for that program or to record that program.

Other functions that the interactive television application may provide include the ability to set favorites or establish preferences or other settings. For example, the user may select a particular channel for the program guide to automatically tune to when the user equipment is turned on. The user may also select favorite programs, favorite channels, etc. The program guide or other interactive television application may provide the user with the ability to establish parental control settings, the ability to search for programming of interest, and the ability to view program descriptions, advertisements, text, graphics, and video, etc. These are merely illustrative examples of interactive television functions that may be provided by interactive television system 10. Other suitable interactive television functions may be provided if desired.

A user may access program listings (e.g., program listings of the type shown in FIG. 8) by using the interactive television application to select an on-screen option such as option 122 or 123 of FIG. 7, by pressing a dedicated guide button such as guide button 96 on remote control 72, by selecting any other suitable button or on-screen option, etc. In the example of FIG. 8, program listings are currently being displayed for television programs that air between 12:00 noon and 1:00 PM. As shown by arrows 140 and 141, the user may use right or left cursor keys to navigate to other times (e.g., to direct the interactive television application to display appropriate screens of program listings 143 for different time periods). If desired, the user may select options or press keys (or use user input interface 118 to otherwise enter suitable commands) that direct the interactive television application to display program listings organized by channel, by genre, by service type (e.g., pay-per-view or regular broadcast television), etc.

Selectable options, such as options 145, 146, 147, 148, 149, 150, 151, and 152, may be provided as part of program guide screen 138 or any other program guide screen for providing access to various interactive television application features. For example, option 145 may be used to display a home screen or main menu, such as menu screen 120 of FIG. 7. Option 146 may be selected to display program listings for channels designated by the user as “favorites.” Option 147 may be selected to display listings of recommended programs using highlight region 142. Scroll indicators 148 and 149 may be used to navigate down and up through program listings. Option 150 may be selected to display information related to video-on-demand services. Option 151 may be selected to search television program listings by title, time, category, or any other suitable criteria. Option 152 may be selected to display information related to digital music services.

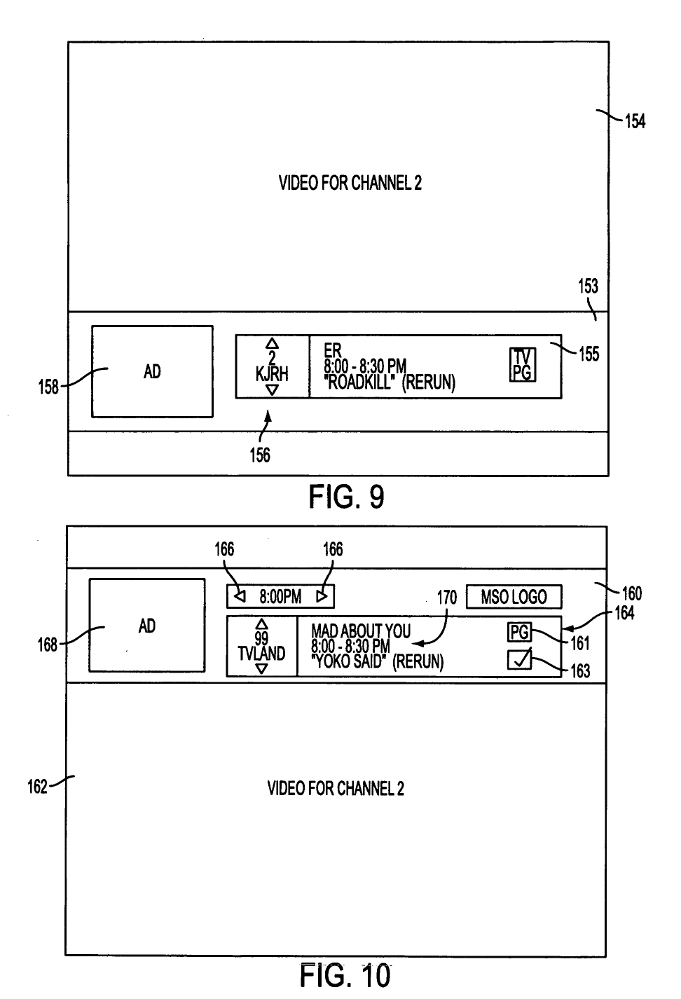

The interactive television application may provide a “flip” tuning feature. As shown in FIG. 9, when the user invokes the flip mode, flip display 153 may be provided over a portion of a channel (i.e., channel 2) that the user is currently tuned to and is watching on display screen 154. Flip display 153 contains information (in region 156) on the program 155 appearing on the current channel (channel 2) to which the set-top box 60 or other user equipment is tuned. The user may change the channel using channel up and down keys on the remote control or using user interface 118 to issue other suitable channel change commands. This simultaneously changes the channel to which the set-top box 60 or other user equipment is tuned and the channel information displayed in region 156 (and the associated program information 155).

The flip display 153 may be removed manually or automatically (e.g., after a few seconds or other suitable time period of user inactivity). When the user starts changing channels again, the flip display 153 may be displayed again.

The flip feature of the interactive television application therefore allows the user to view program information for the channel that the user is currently viewing as the user changes channels. In the example of FIG. 9, the flip display 153 is displayed in the form of an overlay on top of the current channel. If desired, the video for the current channel may be reduced in size and the flip information (e.g., the program title and channel information for the current program) may be displayed at a location on the periphery of the reduced-size video (e.g., at the bottom, side, or top of the reduced-size video).

An advertisement 158 or other content may be provided in the flip display region if desired. Other optional information that may be displayed in flip display 153 includes information on the scheduled broadcast times for the program 155 and ratings information, program descriptions, and other program-related information.

The interactive television application may also be used to provide a browse feature. As shown in FIG. 10, when the user invokes the browse feature (e.g., by pressing an up or down cursor key), browse display 160 may be displayed as an overlay over a portion of the channel (i.e., channel 2) that is being displayed on the user's display screen 162 and to which the user is currently tuned. Browse display 160 may initially contain information on the current channel. For example, browse display 160 may, when initially invoked by the user, contain the title of the current program and information on the current channel such as the current channel number, call letters, and network logo.

When the user presses the up or down cursor key (or enters other suitable commands using user interface 118), the browse display may be changed to display information on the programming available on other channels. In the example of FIG. 10, the user has pressed the cursor keys repeatedly, until the user has browsed to channel 99. The video that is being displayed on display screen 162 has not changed in this example (channel 2 is still being displayed).

As indicated by arrows 166, the user may use right and left cursor keys 82 (or other suitable controls) to browse to other time slots (e.g., to view information related to programming that is scheduled for broadcast at a later time). Browse display 160 may contain an advertisement 168, information 170 on scheduled program times, program descriptions and other program-related information and icons such as check icon 163 (to indicate that a reminder has been set for a given program) and ratings icon 161.

If the user locates a currently available program of interest on another channel, the user may press the OK key 84 to direct the interactive television application to tune the user equipment to that channel.

The browse display 160 may be removed manually or may be removed automatically from display screen 162 after a suitable period of user inactivity (e.g., after a few seconds or a minute or two).

If desired, the browse display can be displayed on the periphery of the video for the current program rather than as an overlay. The video for the current channel may be reduced in size accordingly.

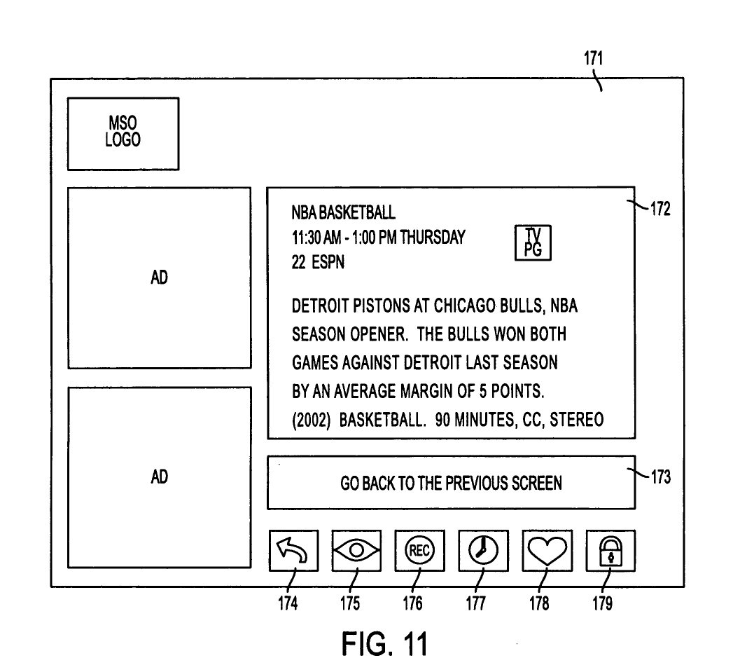

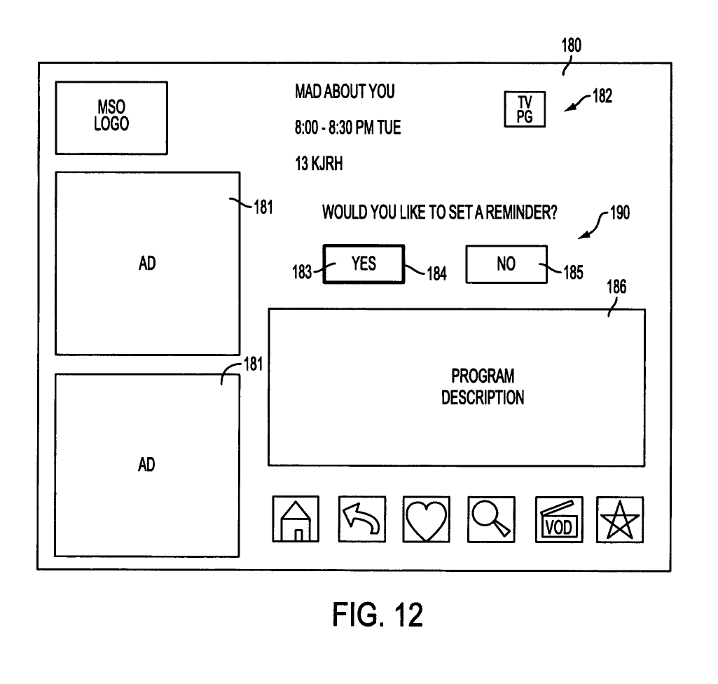

When the user has indicated interest in a program (e.g., by positioning highlight region 142 of FIG. 8 on top of a given program listing, by tuning to a program, by viewing a program listing on the flip banner of FIG. 9 or the browse banner of FIG. 10, etc.), the user may press info key 90 (FIG. 4) to obtain more information for that program. Illustrative info screens 171 and 180 that may be displayed when a user presses info button 90 are shown in FIGS. 11 and 12, respectively. Screens such as screens 171 and 180 may be provided when a user selects a program listing from a interactive television application screen (e.g., program guide screen 138 of FIG. 8). Info screen 171 of FIG. 11 may include a detailed description 172 of a program selected by the user. Description 172 may include, for example, the title, time, channel, and rating of the program, or any other suitable information. As in FIG. 8, selectable options may be provided as part of info screen 171 to provide access to various interactive television application features. For example, option 174 may be used to return to the previous program guide screen. Option 175 may be used to tune to the selected program or set a reminder for the selected program (e.g., the program for which information is displaying in description 172). Option 176 may be selected to display recording options and services for the selected program. Option 177 may be selected to display options for adding a reminder for the selected program. Option 178 may be used to display options for adding the selected program or channel to a user's favorites, and option 179 may be used to display options for providing a parental lock on the selected program. Selectable options for other interactive television application features may also be provided. A highlight region may be used to select any of the selectable options provided by a program guide screen. Information describing a highlighted option may be provided, for example, in information display region 173.

Information screens may include advertisements. For example, info screen 180 of FIG. 12 may include selectable advertisements 181. Information regions on screen 180 such as title region 182 and program description region 186 may be used to display information on the selected program such as title information, ratings information, plot summary information, information about actors, genre, critics ratings, etc.

Region 190 may be used to inform the user of the possibility of setting a reminder for the selected program, of tuning to the channel showing the selected program, of recording the selected program, of purchasing the selected program if it is a pay-per-view program, of parentally controlling the selected program, of configuring a related profile or preference settings, or performing any other suitable action related to the selected program. Region 190 may also be used to provide additional information related to the selected program. The user may position highlight region 184 on top of either yes option 183 or no option 185 or any other suitable options (e.g., options to tune to the channel, to record the program, to purchase the program, to parentally control the program, to configure the preference settings, etc.). When the user presses the OK key 84, the interactive television application may then take appropriate actions. If the user opts to set a reminder for the program listed in the info screen 180, the interactive television application may display a pop-up reminder overlay on top of the video for the channel that the user is currently watching just before the program associated with the reminder is scheduled to begin, or any suitable display screen that is active at the time that the reminder pops up (e.g., a program listings screen).

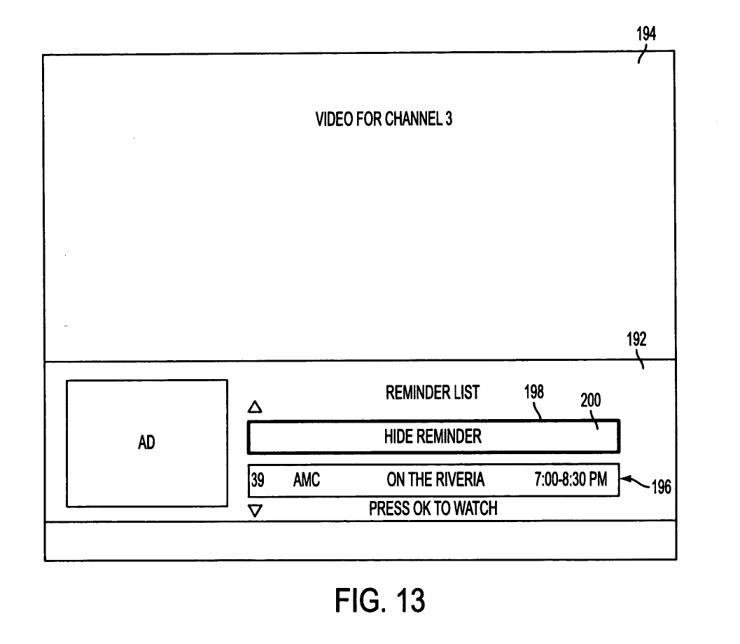

An illustrative reminder is shown in FIG. 13. In the example of FIG. 13, the user is watching channel 3. The current time is 6:58 PM. Previously, the user set a reminder for the program “On The Riviera,” which is scheduled to be shown on channel 39 at 7:00 PM. Because the program for which the user set the reminder is just about to begin, the interactive television application displays reminder list 192 as an overlay on top of the video for channel 3 that is being presented on display screen 194. The reminder list may contain a list of one or more programs for which the user has set reminders. In the example of FIG. 13, one program listing 196 (“On The Riviera”) is displayed.

The user can tune to a program by selecting that program from the reminder list 192. For example, the user may position highlight region 198 on listing 196 and may select that listing by pressing the OK key 84. The interactive television application may then tune the user to the channel for the desired program (i.e., channel 39 in this example).

The user can close the reminder list by pressing the OK key 84 while hide reminder option 200 is highlighted.

The reminder list may be displayed at any suitable time (e.g., at 0-15 minutes before the program of interest is to begin, at a user-selected time before that program, etc.). Moreover, the reminder list may be displayed around the periphery of the video for the current channel and the video for the current channel may be displayed in a reduced-size window. These are merely illustrative examples. Any suitable arrangement may be used to notify the user of upcoming programs or in-progress programs for which the user has set reminders and other programs of interest.

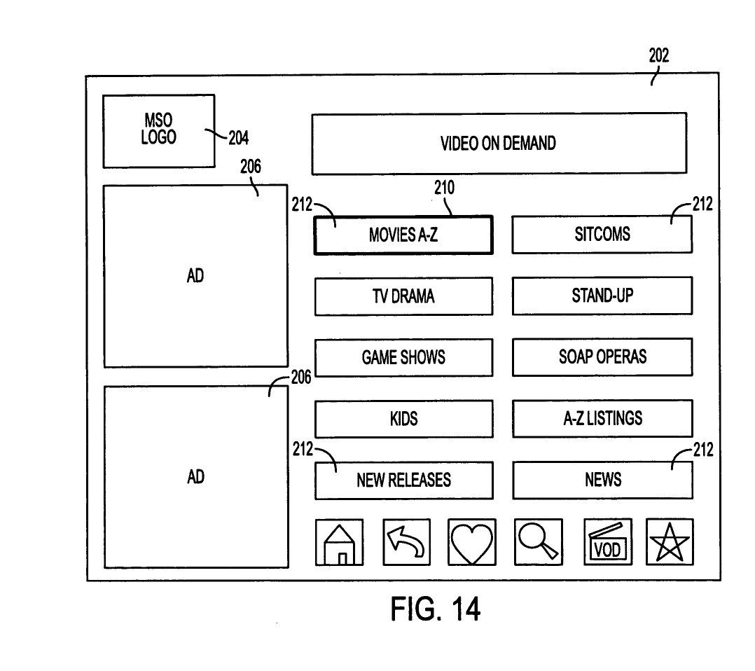

The interactive television application may be used to provide the user with access to video-on-demand content. The user may, for example, be provided with an option such as video-on-demand option 128 on menu screen 120 of FIG. 7. When the user selects option 128, the interactive television application may display a screen such as video-on-demand categories screen 202 of FIG. 14. Screen 202 may include logos such as logo 204, selectable (or non-selectable) advertisements such as advertisements 206, and a screen title 208. The user may position highlight region 210 on an option 212 corresponding to a video-on-demand category of interest.

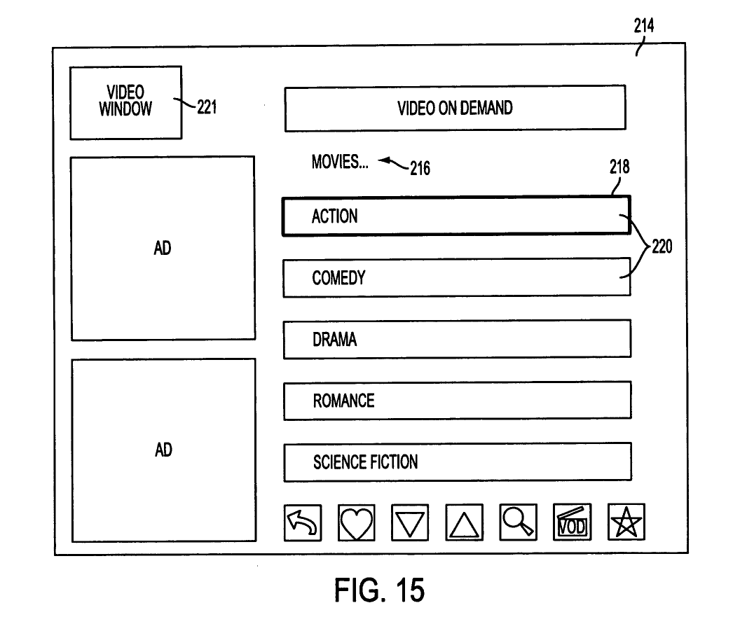

When the user selects the video-on-demand category of interest from screen 202, the interactive television application may display a display screen such as subcategory selection screen 214 of FIG. 15. In the example of FIG. 15, the subcategories screen 214 contains subcategory options 220 corresponding to movies, because (in this example) the user selected movies A-Z option 212 from screen 0.202 in FIG. 14. Video window 221 may be provided in any video-on-demand information screen and may provide information relating to a video-on-demand program selected by the user or any other suitable video information.

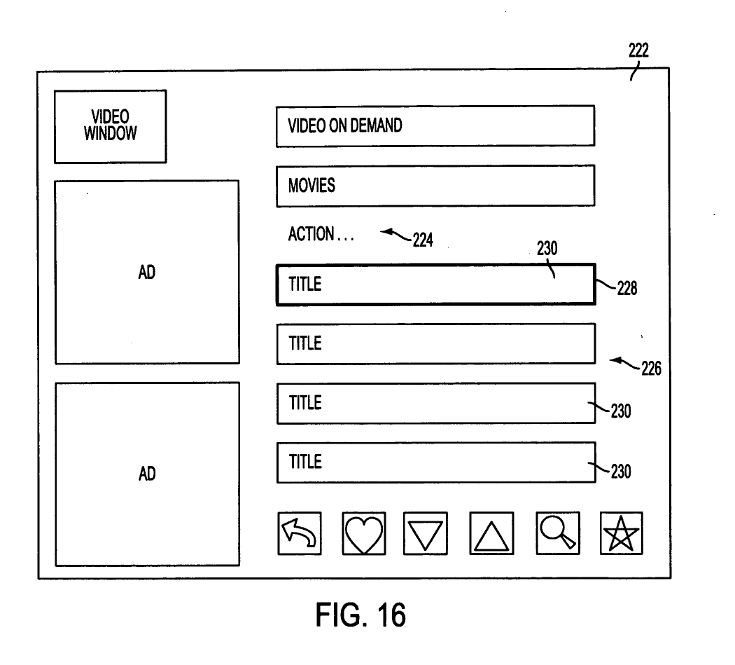

The user may position highlight region 218 onto a desired subcategory 220 and may press OK key 84 to view a list of available video-on-demand content associated with that subcategory. An illustrative display screen 222 that the interactive television application may display for the user when the action subcategory option 220 (FIG. 15) is selected is shown in FIG. 16. As shown in FIG. 16, display screen 222 may include information identifying the selected subcategory 224. Screen 222 may also include a list 226 of titles 230 (or other content indicators). The user may position highlight region 228 on a desired video-on-demand title 230 and may press the OK key to proceed with the selection of that title.

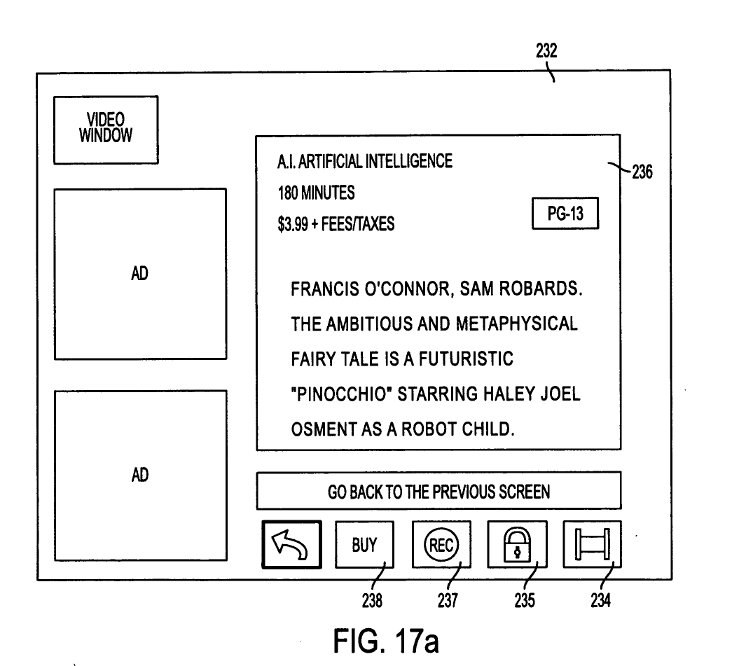

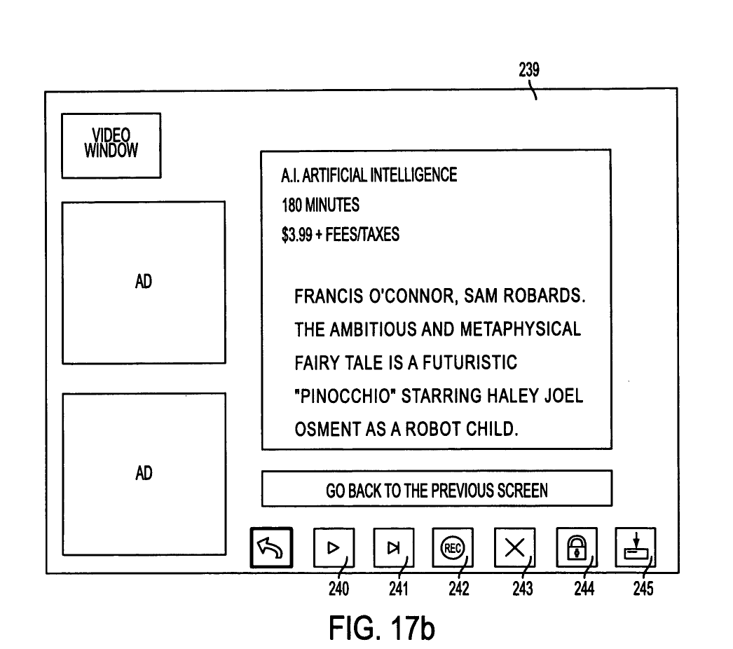

Selecting a desired video-on-demand title 230 from title selection screen 222 may direct the interactive television application to display a video-on-demand information screen such as information screen 232 of FIG. 17a. Screen 232 may include information 236 on the selected video-on-demand content, such as title, run time, price, rating, and a description of the selected video-on-demand content.

Selectable options, such as options 234, 235, 237, and 238 may be provided as part of screen 232 to provide access to various interactive television application features. For example, option 238 may be selected to access options for ordering the selected video-on-demand content. Option 237 may be used to access options for recording the selected content, and option 235 may be used to access options for setting parental control locks for the selected content. If the user selects option 234, the interactive television application may display a video clip containing information on the video-on-demand content of interest (e.g., a promotional video such as a preview, a trailer, a review, etc.). The video clip may be delivered to the user equipment 18 from a server such as server 36 or server 56 of FIG. 1 or from equipment at a service provider such a service provider 50. The interactive television application may also provide the user with additional information on the video-on-demand content in response to the user selecting option 234. Other suitable selectable options may also be provided on screen 232 (e.g., a program package information and purchase option, options for searching program listings for related content, etc.).

If a user requests information for video-on-demand content that has already been ordered, the interactive television application may provide video-on-demand information screen such as screen 239 of FIG. 17b, which may include selectable options different than those provided for screen 232 of FIG. 17a. For example, option 240 may be used to start playing selected video-on-demand content from the program position most recently viewed. Option 241 may be used to present the selected content from the beginning, and option 242 may be used to access options for recording the content. Option 243 may be used to remove the selected content from a listing of the ordered and available content. Option 244 may be used to access options for setting parental control locks for the selected content. If the selected content is being accessed over a network or being provided by a network storage device, option 245 may be used to store the content on a local storage device.

In response to a user ordering selected content (e.g., by selecting an on-screen order option such as option 238 of FIG. 17a, or by using remote control 72 or any other suitable input device 118 to order content, etc.), the interactive television application may deliver the ordered video-on-demand content to the user equipment from a server such as server 36 or server 56 or from a service provider such as service provider 50. The communications paths and communications network 34 of FIG. 1 may be used in delivering the requested content.

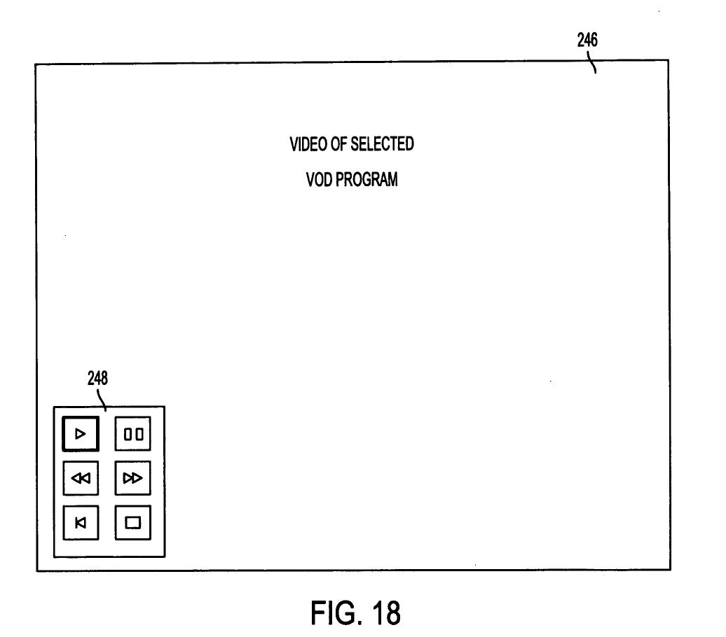

The ordered video-on-demand content may be displayed for the user on a display screen such as video-on-demand playback screen 246 of FIG. 18. As shown in the lower portion of screen 246, interactive options may be displayed in a toolbar 248 or other suitable format. The interactive options 248 (or similar remote control buttons) may allow the user to rewind the video-on-demand content to the beginning, rewind, play, fast-forward, pause, stop delivery of the video-on-demand content, or perform other video playback options. The arrangement of FIG. 18 is merely illustrative. For example, the video-on-demand content may be played back in a reduced size window (of fixed or user-selectable size).

The interactive television system 10 may be used to support video recorder functions. The video recorder functions may be supported using local arrangements (e.g., arrangements in which a personal video recorder or other suitable equipment in the user's home is used to record videos on a local hard drive or other storage device) and network-based arrangements (e.g., arrangements in which network equipment such as servers 36 and 56 or equipment at a service provider such as service provider 50 is used to store video and data for the user). Combinations of these arrangements may also be supported using system 10.

In a local video recorder arrangement (sometimes called a personal video recorder arrangement or local digital video recorder arrangement), video recordings are stored locally on the user equipment. Information on which videos have been recorded may also be maintained locally. Program guide information (e.g., titles, rates, descriptions, categories, etc.) may also be maintained for the recorded videos. When a user desires to view a list of the recordings that the user has stored on the user equipment, the interactive television application may retrieve this information from local storage and may display this information to the user locally on user equipment 18. The user may then select a desired recording to play back.

In a network-based video recorder arrangement (sometimes called a client-server video recorder arrangement), videos may be stored on the network (e.g., at servers such as servers 36 and 56 or at a service provider such as service provider 50). Information on which programs have been recorded for the user may be stored locally and on the network (e.g., at servers such as servers 36 and 56 or at a service provider such as service provider 50).

Network-based recordings may be made in a number of ways. For example, some or all of the regularly-broadcast television programming provided by programming sources 12 may be automatically recorded or copies of this programming otherwise maintained on a suitable network storage device such as server 36, server 56, or equipment at a service provider such as service provider 50. If the user chooses to “record” a program, no actual recording need be made, because a copy of the desired program already exists on the system. With this type of arrangement, virtual recordings take the place of real recordings.

The user may be given a “personal area” on the network. The personal area may be accessed when the user enters an appropriate personal identification number or by virtue of the user's connection to the network through a known or trusted communications path (e.g., when the user is connected through a dedicated cable path to a server at a cable system headend such as a server 56 at television distribution facility 14 of FIG. 1).

The personal area may be used to maintain a list of the video content that the user has recorded. Whenever the user directs the network-based video recorder portion of the interactive television system to make a recording, the system updates the user's personal area to make it appear as though an additional “real” copy of the requested recording has been made. The network-based video recorder implemented with this approach therefore conserves storage space, while providing users with the illusion of access to a network-based video recorder dedicated to their personal use.

Alternatively, there may be no personal area and each user may have access to all previously recorded content to which they had rights when originally broadcast.

As another example, some or all of the content for which a user requests that a recording be made may be recorded by creating actual copies (e.g., digital recordings) of the requested content. These actual copies may be stored on network equipment (e.g., servers such as servers 36 and 56 or equipment at a service provider such as service provider 50).

Programs recorded onto a network server may be copied to a user's local storage.

A combination of these approaches may be used if desired. For example, some content may be automatically retained by the system (e.g., copies of popular programming). The user may make virtual recordings of this material. The presence of the virtual recordings may be reflected in the user's personal area. Other content may be stored in the form of actual recordings at the direction of the user (e.g., less popular content). The presence of these recordings may also be reflected in the user's personal area.

Regardless of the way in which network-based recordings (virtual or real) and local recordings are made, the interactive television application may be used to provide the user with interactive display screens that assist the user in making recordings, managing recordings (e.g., editing recordings, deleting recordings, renaming recordings, sending recordings to other users over the communications paths of FIG. 1, etc.), playing back recordings, viewing information about recorded programs, etc.

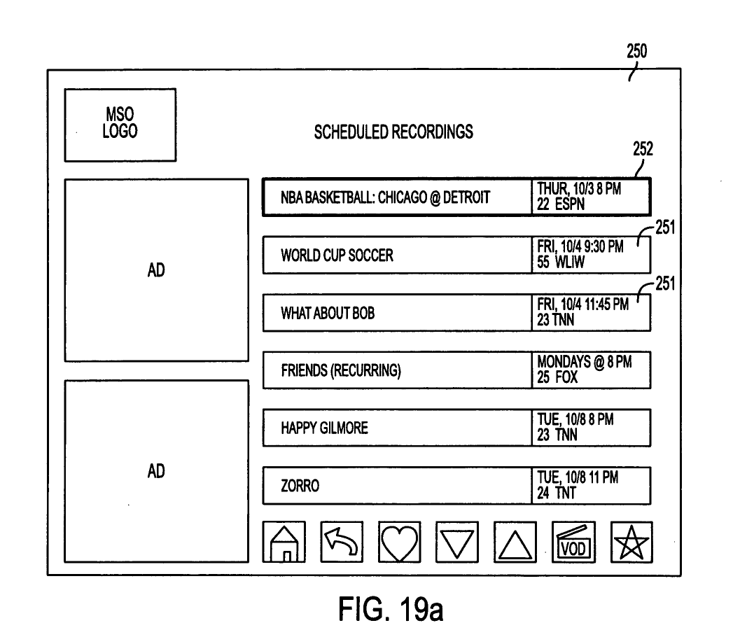

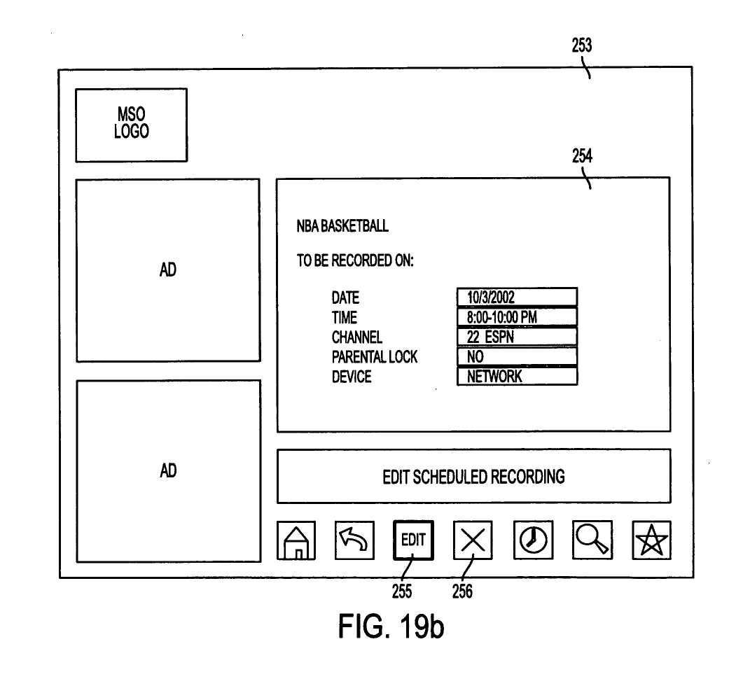

Once a program has been selected by a user for recording, the selected program may be presented in an interactive list of programs scheduled to be recorded. An illustrative scheduled recordings screen 250 that may be displayed for the user on user equipment 18 is shown in FIG. 19a. Screen 250 may be displayed by the interactive television application when the user selects an option provided by another program guide screen, such as program guide screen 120 of FIG. 7 or any other suitable option. Screen 250 may include, for example, a list of programs scheduled to be recorded 251. A highlight region 252 may be used to select a scheduled recording from the list. The user may position highlight region 252 on a desired scheduled recording and select the scheduled recording using an appropriate key of remote control 72.

Information about a scheduled recording selected by the user may be presented in a screen such as screen 253 of FIG. 19b. Screen 253 may include scheduled recording information 254, which may show the date, time, and channel for which a program is to be recorded. Information 254 may also indicate which device has been designated to record the program and whether a parental lock is set for the program scheduled to be recorded. The user may edit information 254 by selecting edit option 255 using a highlight region. Other selectable options may be provided in screen 253, for example cancel option 256 which the user may select to cancel the scheduled recording.

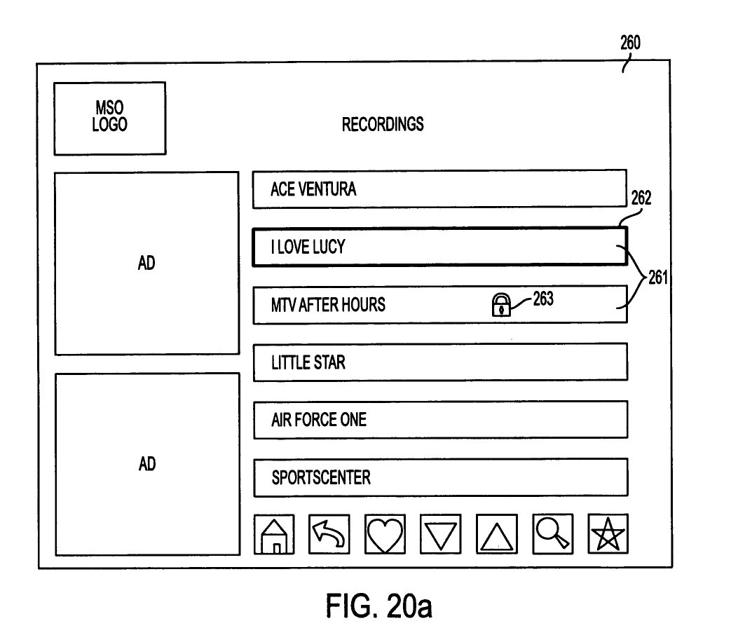

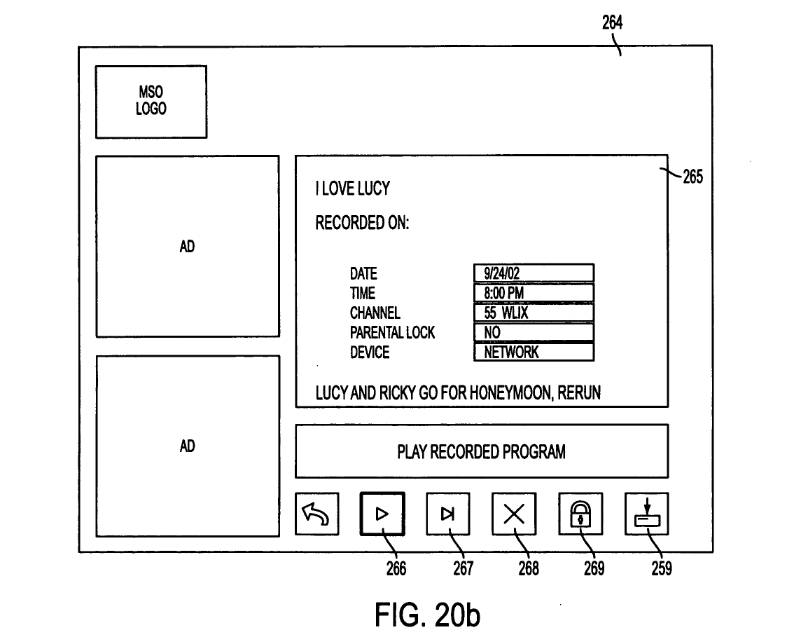

Once a program has been recorded, a program guide screen may be presented to display recorded programs. An illustrative video recordings screen 260 that may be displayed for the user on user equipment 18 is shown in FIG. 20. Screen 260 may be displayed by the interactive television application when the user selects an option provided by another program guide screen, such as program guide screen 120 of FIG. 7 or any other suitable option. The recordings 261 may be local recordings that are stored on the user's equipment 18 or may be real or virtual network-based recordings (e.g., network-based content stored on equipment such as server 36 or server 56 or at service provider 50). In a network-based video recorder environment with a personal area, screens such as screen 260 provide access to all or part of the user's personal area. The user may navigate through the personal area using remote control 72 or other suitable user interface 18.

Screen 260 may include a list of the user's recordings 261. Recording listings may include the time and channel the program was recorded or any other suitable information. The user may position highlight region 262 to select a recording of interest (e.g., to view that recording, to view information about that program, to delete the program, etc.). The user may position highlight region 262 on a desired recording and select the recording using an appropriate key of remote control 72.

Information about a recording selected by the user may be presented in a screen such as screen 264 as illustrated in FIG. 20b. Screen 264 may include recording information 265, which may show the date, time, and channel the program was recorded. Information 265 may also show whether a parental lock is set for the recording and what device has been designated to store the recording. The user may play the recording by selecting option 266. The user may play the selected recording from the beginning by selecting option 267. Option 268 may be selected to delete the recording from the list of recordings. Option 269 may be used to set a parental lock for the selected recording. If the selected recording is being stored on a network video storage device, the user may select option 259 to transfer the recording to a local storage device. On-screen options may be selected using a highlight region and a remote control, or by any other suitable method.

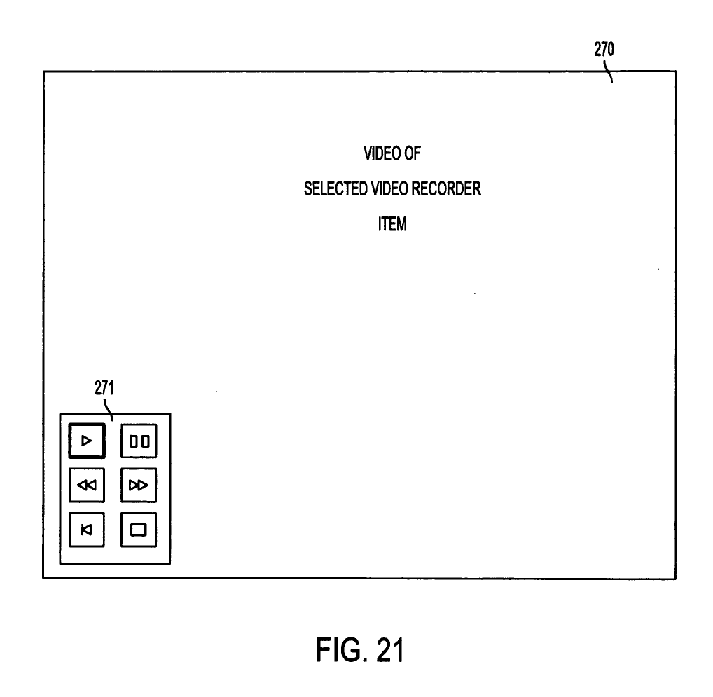

When a given recording is selected for play back, for example by selecting play option 266, a display screen such as display screen 269 of FIG. 21 may be presented. Display screen 269 may include the video 270 of the selected program that is being played back to the user and options 271 for controlling the video. Options 271 may, for example, include options that allow the user to rewind the video to the beginning, to rewind or reverse the video, to play the video, to fast-forward the video, to pause the video, or to stop the video. Control of these functions and other interactive television application functions may be supported using on-screen options, dedicated or multi-purpose keys on remote control 72 or other user devices, or other suitable arrangements involving user interface 118. When on-screen options are used, the options may be displayed in the form of one or more overlays on top of video 270 or video 270 may be provided in a reduced-size window and the options displayed outside of this window.

With the arrangement of FIGS. 20 and 21, the user can browse the user's recordings and can play back (and control the playback) of these recordings. Recordings that are stored locally on user equipment 18 may be played back by retrieving these recordings from the local hard drive or other storage on which the recordings are maintained. Recordings that are stored on the network may be played back from the network equipment on which the recording content is stored. User equipment 18 may receive such content in the form of a real-time video stream or a file download and the interactive television application may play back the received content using a display screen arrangement of the type shown in FIG. 21.

The user may record programming by indicating interest in a program for recording by highlighting a program of interest on a suitable display screen provided by the interactive television application and pressing a record key, by selecting a program for recording from a flip or browse display, by tuning to a desired program and selecting an appropriate record button, by selecting a record option from an information screen, etc. For example, the user may highlight a program in a program listings screen such as screen 138 of FIG. 8, or may display a program listing of interest on a flip display such as flip display 153 of FIG. 9 or on a browse display such as browse display 160 of FIG. 10. When the user presses a suitable remote control key such as record key 86 of FIG. 4, the interactive television application may record the desired program.

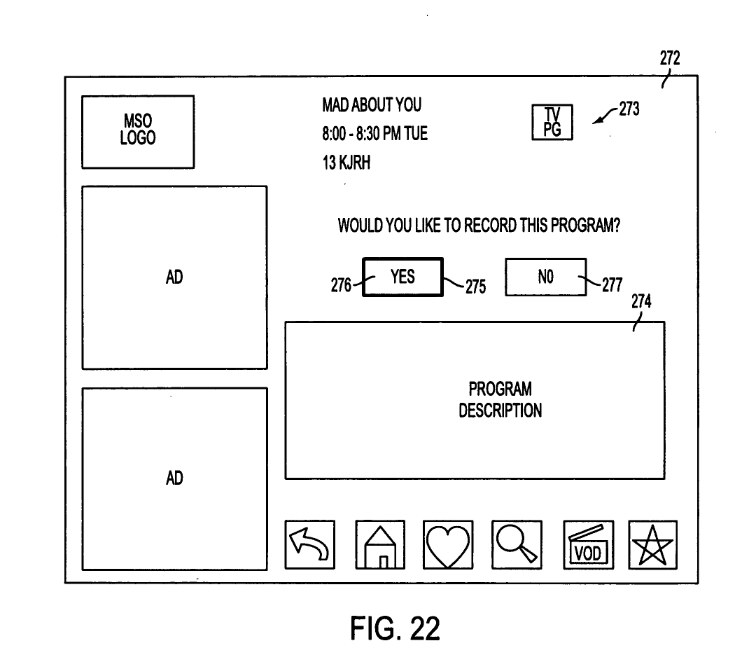

The interactive television application may automatically record the program that the user selected or may provide one or more additional confirmation and information screens after the user presses the record key 86. As an example, the interactive television application may display a screen such as record set-up screen 272 of FIG. 22. As shown in FIG. 22, screen 272 may include title and ratings information in region 273 and a program description 274. The user may be provided with information on the scheduled broadcast time for the selected program. If the user desires to record the program, the user may position highlight region 275 on top of YES option 276 and may press OK key 84. If the user does not wish to record the program, the user may position highlight 275 on top of NO option 277 and may press the OK key 84. If desired, other options such as series recording options, recording quality options, and buffer time options may be provided.

When the user directs the interactive television application to record a given program, the interactive television application will record the program using the local capabilities of user equipment 18 or using the network-based video recorder capabilities of the system 10, depending on the equipment of the user, the capabilities of system 10, and system and user settings.

After the program has been recorded, the user may use the interactive television application to view information on the user's recordings (e.g., using a display screen arrangement of the type shown in FIG. 20). These techniques for supporting recording functionality in the interactive television application are merely illustrative. Any suitable arrangement for recording (as real recordings or as virtual recordings and locally or on network equipment) may be used if desired.

The interactive television application may allow the user to establish parental control settings. For example, the user may lock a particular program, a program rating, a channel, a type of content (e.g., violent or sexual content), or may establish a parental control setting that blocks all television viewing during a particular period of time. A user may be required to enter a personal identification number (PIN) to unlock blocked content.

With one illustrative arrangement, a parent (or other suitable user) may select a program to block by highlighting the program listing for that program in a suitable program listings screen (e.g., a screen such as screen 138 of FIG. 8). After highlighting the program to be blocked, the parent may press lock key 92 on remote control 72 (FIG. 4). The parent may also access options for setting parental locks by selecting an on-screen parental control lock option provided by the interactive television application (e.g., option 234 of FIG. 17a, option 244 of FIG. 17b, etc.).

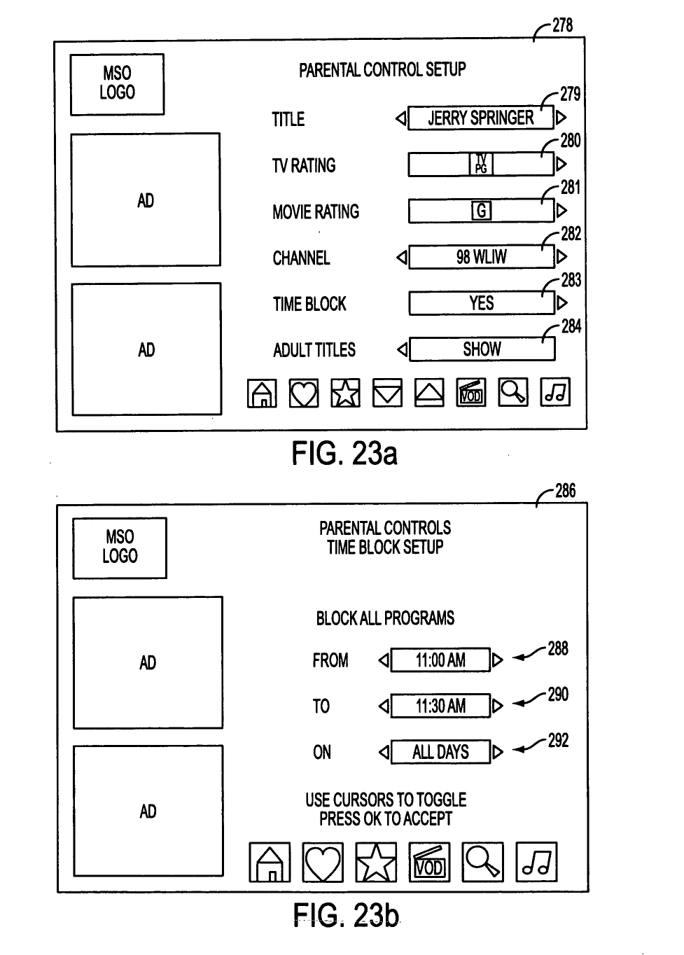

In response to a user selecting an on-screen option or remote control key to access parental control lock options, the interactive television application may display a display screen such as parental controls display screen 278 of FIG. 23a. Parental controls options may be accessed from a main menu, a selected program, or any other suitable program guide screen. Users may set parental locks for a selected program or a range of programming by selecting from various criteria. For example, users may select to block programs according to title 279, TV rating 280, movie rating 281, channel 282, or any other suitable criteria. Block ratings options 280 and 281 may allow users to block all programming with a given rating (e.g., the same rating as the selected program or a user-input rating or range of ratings). The user may be provided with other options for applying parental lock settings by selecting, for example, (YES/NO) time lock option 283. A user may also select to hide or show adult titles by selecting option 284. Other selectable options may also be provided in screen 278.

If the user has selected “YES” for time block option 183, a time block sub-menu may be provided, for example, screen 286 of FIG. 23b. The user may use the on-screen options of screen 286 to set a beginning time (option 288) and ending time (option 0.290) for the parental control time period. The user may use option 292 to make the parental control setting effective for all days of the week, certain groups of days (e.g., week days or weekend days), or a particular day or days. The user may press OK key 84 when finished. Other selectable options may also be provided as part of screen 286.

The parental control screens 278 and 286 of FIGS. 23a and 23b are merely illustrative. Any suitable on-screen options or other user interface arrangement may be used to allow a parent (or other user) to block (parentally-control) programming airing during a particular period of time, programming on a particular channel or channels, programming with a certain rating, individual instances of certain programs, etc.

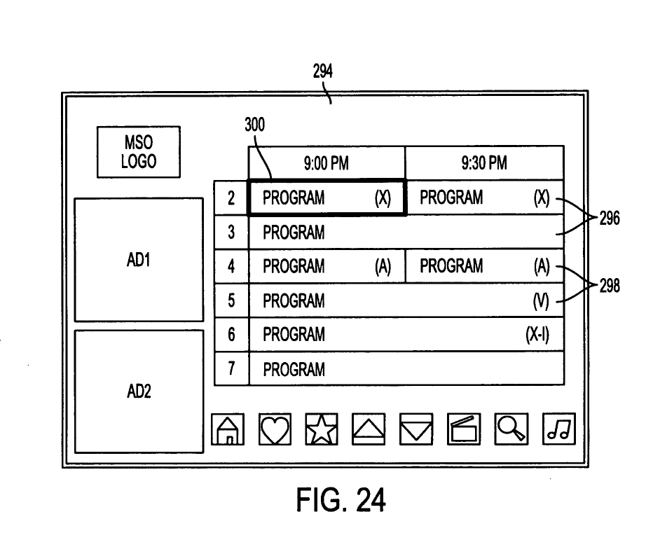

FIG. 24 shows an illustrative program listings grid display screen that may be displayed by the interactive television program guide application in accordance with various embodiments of the present invention. Illustrative program listings grid screen 294 may include program listings 296 arranged in a grid format by time and channel. In FIG. 24, the program listings grid is displaying program listings information, such as program titles, for the current and future times (e.g., programming in the 9:00-10:00 PM time slot), wherein the current time may be between 9:00 PM and 9:30 PM. Screen 294 and other program listings display screens may also include logos, advertisements, navigational icons, and other suitable interface elements.

Icons 298 or other suitable visual indicators may be used to indicate the status of the various programs in illustrative grid screen 294. The use of icons 298 as visual indicators in the example of FIG. 24 is merely illustrative. In some embodiments, information on the status of programs 296 may be provided using any suitable visual indicator. For example, the colors of the program listings (e.g., grid cells) may be changed such that a given color represents a different program status. In other embodiments, the visual indicators may be displayed as program listings of different size or background texture. In some embodiments, program listings may blink or use other suitable motion effects. Text or graphic information may also be used to annotate the listings, etc. For example, a program title that has been recorded and stored by the system may be associated with the word “RECORDED” or by a small videotape icon, either of which may provide the user with information that the program has been recorded and may be available for viewing. Audio effects may also be associated with each program listing (e.g., one or more different tones may be played when a program listing is highlighted, etc.). However, any suitable visual indicators may be displayed to provide the user with information relating to the program.

The visual indicators associated with a program listing may be used to provide the user with information relating to that program. For example, an “X” indicator may be used to indicate that the indicated program has been recorded, is being recorded, or will be recorded. Individual indicators may be used for each of these different status subcategories. For example the indicator “X-R” may be used to indicate that a given program has been recorded. The indicator “X-I” may be used to indicate that a given program is currently in the process of being recorded. The indicator “X-W” may be used to indicate that a given program is scheduled to be recorded. It should be noted that any other suitable indicator may also be used.

In some embodiments, an “A” indicator may indicate that a program is available for recording. Such an indicator may be beneficial because some of the programs are copy-protected or are otherwise not available for network and/or local recording.

The recording indicators in FIG. 24 are merely illustrative. If desired, combinations of such indicators may be used (e.g., a black icon may be used to indicate that the status of a program is either scheduled to be recorded (“X-W”) or in the process of being recorded (“X-I”) or available for recording (“A”) and a yellow icon may be used to indicate that the program has been recorded (“X-R”)).

In addition, to assist users in environments that support both local and network-based video-recording capabilities, indicators may be provided that indicate whether a program is available for recording only on the network-based video recorder, only on a local recording device, or both. The interactive television program guide application may also provide visual indicators informing the user that a program has been, is being, or will be recorded only on the network-based video recorded, only locally on the recording device, or both. Some programs may not be available for recording due to, for example, legal restrictions, lack of available equipment at a cable headend, expiration of a limited time of availability for recording, etc. In one suitable approach, programs may be generally recorded on local user equipment 18 (e.g., on the user's local personal video recorder), but only certain programming may be available for recording or scheduled for automatic recording using the network-based equipment of system 10 (i.e., server 36, server 56, or equipment at service provider 50). Using this approach, the interactive television program guide application may provide visual indicators that are associated with the program listings to inform the user of which programs may be recorded on the network and which programs the user may be recorded locally. Other visual indicators described in connection with FIGS. 24-27 may also be used to indicate the status of these programs on the network or local video-recorder (e.g., which programs have been recorded, are scheduled for recording, are currently being recorded, etc.). In some embodiments, the interactive television program guide application may display visual indicators that they are associated with the program listings in a grid-type format or any other suitable list displayed by the interactive television program guide application.

Other types of program status may also be indicated by indicators. For example, a “V” indicator may be provided to indicate that the associated program is available for ordering as a video-on-demand program. If, for example, a movie is scheduled to be broadcast, the title for that movie may be marked in the program listing (e.g., with a “V”) to indicate that the user may order a video-on-demand version of the movie in advance of the broadcast schedule time or after the broadcast schedule time. In some embodiments, a fee may be associated with the video-on-demand order. A user may prefer to order the video-on-demand version of the movie because it is available at a more convenient time than the broadcast version of the video or because the video-on-demand version has no commercials (or fewer or different commercials).

Screen 294 and other screens generally may also include a highlight region 300. In response to the user, for example, positioning highlight region 300 on a program listing using cursor keys 82 (FIG. 4) and pressing OK key 84, the interactive television application may tune to the program associated with the currently highlighted program listing. In another suitable embodiments, the interactive television application may obtain additional information for a future program. The user may also press info key 90 to obtain information about the currently highlighted program. Lock key 92 and record key 86 may be used to parentally control or schedule a recording for a highlighted listing.

In some embodiments, the interactive television program guide application may allow users to view program listings for additional channels by, for example, pressing the down cursor key until the highlight region 300 has reached the last row of the program listings grid. Subsequent down-cursor-key presses may be used to direct the interactive television program guide application to display program listings for higher-numbered channels.

In some embodiments, the interactive television program guide application may allow users to view program listings for future times by, for example, pressing the right cursor key until the highlight region 300 has reached the rightmost program listing (e.g., cell) in a given row. Subsequent right-cursor-key presses may be used to direct the interactive television program guide application to display program listings for future time slots (e.g., 10:00 PM to 11:00 PM, etc.).

In some embodiments, the interactive television program guide application may allow the user to view past program listings. For example, the user may move the highlight region 300 to the left by pressing the left cursor key on the remote control. The user may move the highlight region 300 to the left until reaching the leftmost program listing (e.g., cell) in a given row. For example, the interactive television program guide application may store two weeks of past program listings. Accordingly, the interactive television program guide application may only allow the user to view past program listings that are less than two weeks old.

Additional left-cursor-key presses may be used to scroll the program listings grid in the reverse direction (e.g., back in time). Scrolling may be provided by the interactive television application using a smooth or continuous scrolling operation or by a discontinuous cell-wise or page-wise stepping operation, or using any other such approach for moving the displayed program listings to replace them with a new set of listings. These continuous and discontinuous repositioning operations are referred to herein as “scrolling.”

In response to the user performing the backwards scrolling operation, the interactive television application may display program listings for programs that have been recorded, are in the process of being recorded, or that are available through the video-on-demand services of the interactive television application. It should be noted that using the cursor keys is merely one illustrative approach in which to cause the grid or list of FIG. 24 to scroll or be repositioned. Any other suitable remote control command or user input may be used if desired.

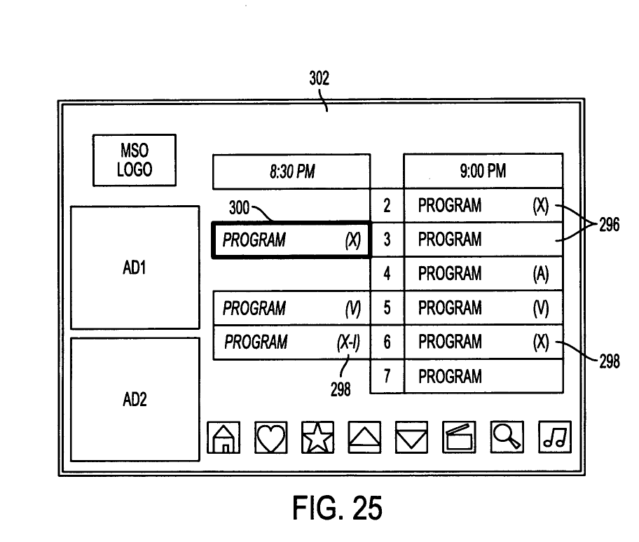

FIG. 25 shows an illustrative display screen that may be displayed by the interactive television application when the user scrolls the program listings grid in the backwards direction past the current time in accordance with various embodiments of the present invention. Referring to screen 302 shown in FIG. 25, the current time may be 9:00 PM or later. Accordingly, the 8:30 PM time slot as shown in screen 302 represents a time prior to the current time, such that the programs listed in the 8:30 PM time slot have already started or have already ended. The program listings grid of FIG. 25 includes the program listings for the 9:00 PM time slot, but the program listings for 9:30 PM have been dropped because they have been scrolled off of the screen. In response to the user scrolling the program listings grid in the backwards direction by, for example, using the left cursor key on the remote control, the interactive television program guide application may provide the user with past listings. As shown in FIG. 25, the user is provided with past listings for the 8:30 PM time slot. The highlight region 300 has been moved to the row for channel 3 because there is no past program listing to highlight in the row corresponding to channel 2.

Additional listings are shown under the time slot for 8:30 PM. These listings correspond to video content that the user may access, even though the time slot of 8:30-9:00 PM has passed. Programs may be listed for time slots corresponding to times before the current time if those programs have been recorded on the network (as either real recordings or virtual recordings in the user's personal area) or when those programs have been recorded locally on the user equipment 18 (also as either real or virtual recordings). For example, in FIG. 25, the highlighted program listing is marked with an “X” to indicate that the program has been recorded. In some embodiments, the recorded program may be listed under the time slot and channel at which the it was originally available (e.g., the original broadcast time and channel). In this manner, a user may more easily locate the recorded program listing at its original broadcast time and channel. The recorded program listing may also be listed under the most recent past time slot, regardless of when it was originally broadcast or recorded. The recorded program listing may also be listed in the grid in place of a later-scheduled rerun of the same program, thereby providing the user to view the already-recorded program instead of the scheduled rerun.

In some embodiments, programming, such as video-on-demand programs, may be provided (e.g., shown as available on the network) from a video-on-demand service implemented on the system. For example, the interactive television program guide application may determine that the program on a given channel, while not recorded by the user, is an available video-on-demand program. In response to determining that the program is an available video-on-demand program, the interactive television program guide application may display a “V” (for video-on-demand content) with the corresponding program listing to indicate that the program is available on-demand. In another example, the interactive television program guide application may display a “V” with every program listing on a channel (e.g., channel 5) because the channel only provides video-on-demand content.

In the example of FIG. 25, there is no program listing for channel 2 under the 8:30 PM time slot because this program was not recorded and is not available as a video-on-demand program. The incorporation of empty cells in the program listings grid in place of unavailable programs provides the user with the information that the program is unavailable for viewing. Empty cells also remove extraneous visual information from the program listings grid, other than programs that the user is allowed to select and direct the application to take an action on. For example, as shown in FIG. 25, the program under the 8:30 PM time slot for channel 3 is marked with an “X” to indicate that it has been recorded, while no program was recorded for channel 4 at 8:30 PM.

In FIG. 25, the program being shown on channel 6 at 9:00 PM started at 8:30 PM. Recording for this program started at 8:30 PM and continues to the current time, as indicated by the recording-in-progress “X-I” icon. In this manner, the user is provided with the information that a portion of the program that has already been broadcast (i.e., the portion from 8:30 PM to 9:00 PM) has been recorded but is still being recorded. With this information, the user is made aware that this recorded portion does not constitute the entire program.

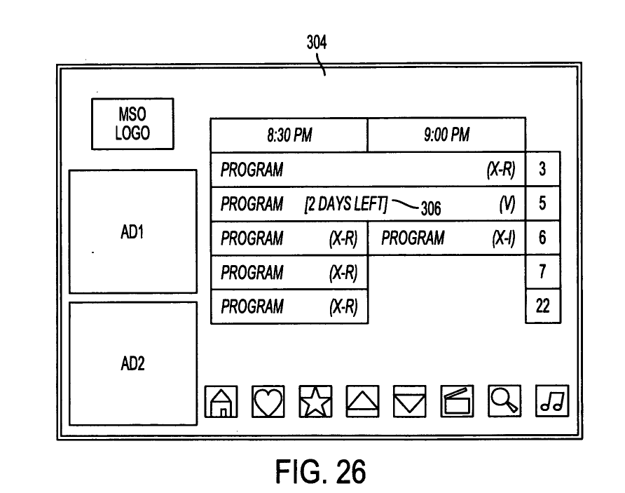

In some embodiments, the interactive television program guide application may allow the user to scroll to program listings at earlier times (e.g., earlier days). FIG. 26 shows an illustrative display screen that may be displayed by the interactive television program guide application in response to the user scrolling back through program listings in accordance with various embodiments of the present invention. As shown in FIG. 26, the user has scrolled another half-hour time slot in the backwards direction. In response to the user scrolling through past program listings, the interactive television program guide application may collapse or remove some or all of the empty rows in the program listings grid. For example, if no programs were recorded for a given channel, then the cells corresponding to those unavailable or inaccessible programs may be empty or blank. If the interactive television program guide application determines that a given row consists entirely of empty or blank cells, instead of displaying an empty or blank row the interactive television program guide application may collapse the remaining grid, thereby removing the blank row. Collapsing the grid in this manner may provide additional space to display, for example, other channels or any other suitable information. Similarly, the interactive television program guide application may collapse or remove some or all of the empty columns in the program listings grid. For example, if no programs were recorded for a given time period, then the cells corresponding to those unavailable or inaccessible programs may be empty or blank. Other suitable approaches for removing or minimizing empty or blank spaces may also be performed by the interactive television program guide application.

If all or a sufficient number of the program listings for a given channel or row are blank, then the row may also be blank. The program listings grid may be displayed with one or more of the empty rows for consistency, or the one or more of the empty rows may be omitted to conserve on-screen space. Omitting empty rows may allow the interactive television application to display additional rows that contain listings of recorded, accessible, or available programs. In FIG. 26, the program listings for channels 2, 4 and 8-21 have been omitted because no programs were recorded for these channels between 8:00 PM and 9:00 PM and no video-on-demand content is available for these channels. By removing empty rows to allow the interactive television application to display additional rows having listings of accessible or available (such as recorded) programs, the interactive television application provides the user with the opportunity to view more available programs with minimal scrolling.

As shown in FIG. 26, the program that was recorded for channel 3 between 8:00 PM and 9:00 PM is marked with an “X-R” icon to indicate that the program has been recorded. The program on channel 5 in the 8:00 PM to 9:00 PM time slot is marked with a “V” icon to indicate that this program corresponds to available video-on-demand content. The interactive television application may provide the user with additional information relating to the video-on-demand program, such as a label or an icon 282. Icon 282 indicates that the video-on-demand program is only available for viewing for the next two days. An icon, label, or any other suitable indicator may be used to indicate that the availability of the content will expire, will no longer be accessible, will change in price, or that any other attribute of the content will change.

In some embodiments, recorded programs or video-on-demand programs may expire after a period of time. This expiration may be part of a service, in which the recorded program is available for viewing by the user for a limited time, or may be a mechanism to conserve storage space in the local or network-based video recorder. In FIG. 26, program 306 is a video-on-demand program that is only available for two more days. Such content may also expire after any suitable period of time (e.g., a few hours, a few days, a month, year, etc.). Rather than expiring, the price of the content may change (e.g., the price may go up or down as time passes).

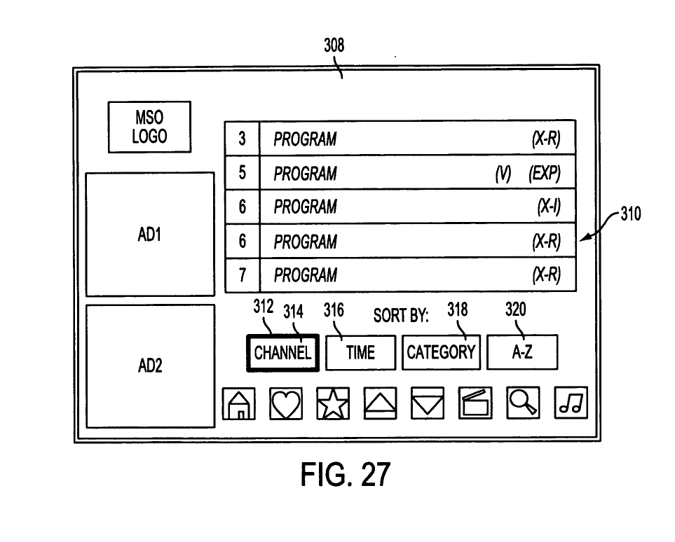

If desired, a screen such as illustrative sorting screen 308 of FIG. 27 may be displayed by the interactive television application when the user scrolls backward from screen 302 of FIG. 25. Screen 308 of FIG. 27 includes a list 310 of recorded programs and video-on-demand programs. The programs in list 310 may be labeled with suitable identifiers that indicate which types of recordings are present. Programs that are being recorded at the current time (e.g., locally or on the network-based video recorder) may be labeled with an indicator such as “X-I.” Programs that have already been recorded may be labeled “X-R” and video-on-demand content may be labeled as “V.” Video-on-demand content may also be labeled “EXP” to indicate that the content will soon expire (e.g., that it will not be available or that it will not be available at the same price or same terms and conditions). Recorded programs on a local recording device or a network-based video recorder may also be labeled to indicate their expiration status. For example, a listed program may be associated with suitable label (e.g., “TWO DAYS”) or icon that indicates, for example, that the recorded will expire and become unavailable in two days.

In some embodiments, when the user scrolls the program listings grid backwards in time, recorded programs and video-on-demand programs available for viewing by the user may be displayed as a list by the interactive television program guide application as shown in FIG. 27. In FIG. 27, there are two program listings in list 310 for programs that were recorded on channel 6. One program has already been recorded and is marked “X-R.” The other program (e.g., the program that started at 8:30 PM and that is still running at the current time of 9:14 PM) is marked “X-I” to indicate that recording is in progress. Either of these programs or the other programs in the lists and screens of FIGS. 24, 25, 26, and 27 may be watched immediately by highlighting the desired program with the highlight region and by pressing the OK key or by using other suitable user inputs. The requested video content may be displayed immediately or intermediate order screens or other suitable screens may be displayed that allow the user to enter purchase information, PIN information, etc.

As shown in the lower portion of screen 308, the interactive television application may allow the user to sort the lists of recorded programs and video-on-demand programs. The user may use highlight region 312 to select a desired sort option. If the user selects a channel sort option 314, the interactive television application may display by-channel screen 308 with the list 310 sorted by channel number. If the user selects a time sort option 316, list 310 may be presented as a time-ordered list with the most recent recordings first (or last). If the user selects a category option 318, the interactive television application may sort the programs in list 310 by category. If the user selects A-Z option 320, the interactive television application may generate an alphabetically ordered list of recordings (and, if desired, video-on-demand content corresponding to scheduled programs or other video-on-demand content). These sort options are merely illustrative. Any suitable on-screen options may be provided to help the user sort and organize the program information on screens such as screen 308.

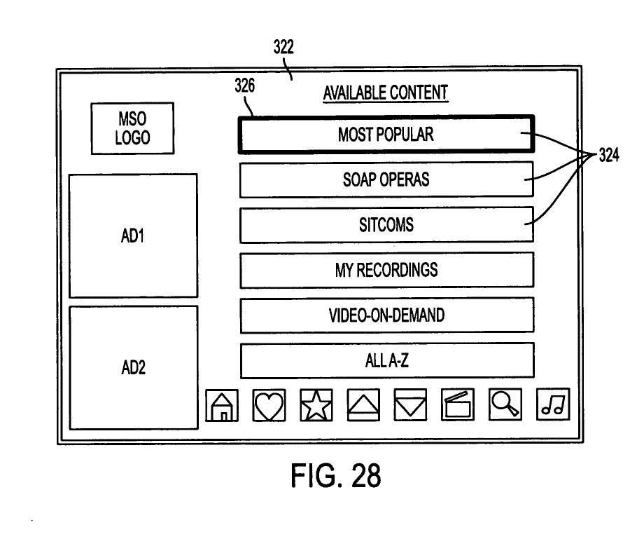

FIG. 28 shows another illustrative screen that may be displayed when the user scrolls backward in time past the current time in a program listing in accordance with various embodiments of the present invention. Screen 322 of FIG. 28 includes user-selectable on-screen options 324. The user may use remote control 72 or any other suitable user interface to position highlight region 326 on top of a desired option. The interactive television application may provide options 324 to display available recordings (and, if desired, video-on-demand content corresponding to scheduled programs or other video-on-demand content) by different categories. The categories may include, for example, “most popular” or other ratings-based groupings, “soap operas,” “situation comedies,” or other genre-based groupings, “my recordings” (for access to the user's locally-recorded recordings or the user's real or virtual recordings in the user's personal area on network-based video recorder equipment), “video-on-demand” for videos that are available both as recordings or in the schedule grid and as video-on-demand items or, if desired, for any other video-on-demand content, and “all A-Z” for an alphabetical listing of recordings (and, if desired, video-on-demand content corresponding to scheduled programs or other video-on-demand content).

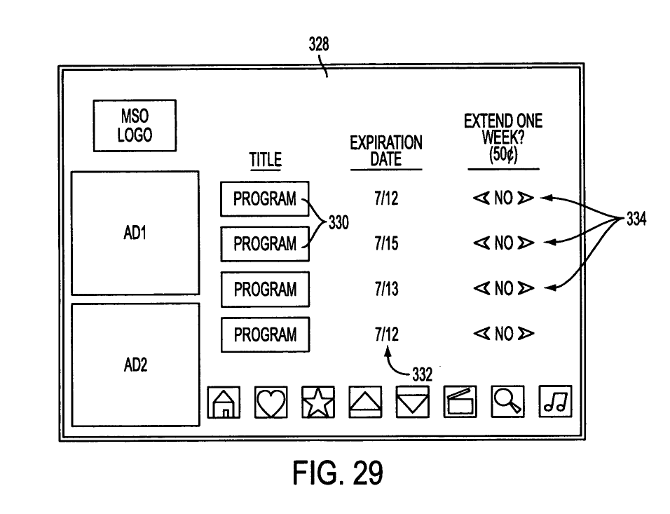

FIG. 29 shows an illustrative program listings screen that the interactive television application may display in response to the user selecting an option, such as the “all A-Z” option of FIG. 28. Screen 328 may include an alphabetical listing of recordings (and, if desired, video-on-demand content corresponding to scheduled programs or other video-on-demand content). Expiration information 332 may be provided that indicates dates and times after which certain programs will no longer be available (or will be available under different terms and conditions). In some embodiments, the interactive television application may allow the user to extend the expiration date of a given program by using an associated extension option 334. Cursors 82 may be used to toggle a desired option 310 appropriately. A fee (e.g., 50 cents) may be charged by the interactive television application when the user requests the extension of the expiration date.

Programs may be recorded automatically for the user (e.g., locally on the user equipment 18 or on the network-based video recorder using equipment such as server 36 or server 56 or equipment at service provider 50). Automatic recordings may be made in the form of real recordings (newly created digital copies) or in the form of virtual recordings (by creating a pointer or other data entry in an appropriate folder or personal area on the network, or on the local PVR).

Recordings may be generated automatically based on any suitable criteria. For example, recordings may be generated automatically when a user sets a reminder for a program but (as determined by the interactive television application) does not watch that program. Recordings may also be automatically made when the interactive television application determines that a given program matches or satisfies the user's preferences (and optionally if the user does not watch the program).

An advantage of this arrangement is that programs that are likely to match the user's programming preferences may be recorded automatically without requiring specific requests from the user. This automatic recording of programs that may be of interest to the user may result in the user being less likely to miss such programs, such as by overlooking it in the program listings or by forgetting to record it. Moreover, in an arrangement that provides the user with the opportunity to view program listings that include programs that have been recorded, are being recorded, or are scheduled for recording (e.g., by scrolling program listings grid backwards before the current time, or by displaying a list of recorded programs, as described herein), such program listings may include programs recorded automatically in accordance with the user's programming preferences. Accordingly, such program listings may be enriched with such recorded programs that are of particular interest to the user because their selection for recording was based on the user's preferences.

Information relating to the user, such as the user's preferences (e.g., the user likes Seinfeld and dislikes action movies and R-rated comedies) may be gathered by the interactive television program guide application by direct input by the user (e.g., by the user inputting preferences to the program guide application, or by monitoring user selection of program guide options, etc.) or may be gathered automatically (e.g., by monitoring the user's viewing habits, recording-scheduling and reminder-setting activities by the user, by monitoring which advertisements and other interactive content the user selects or interacts with during operation of the interactive television application, etc.).

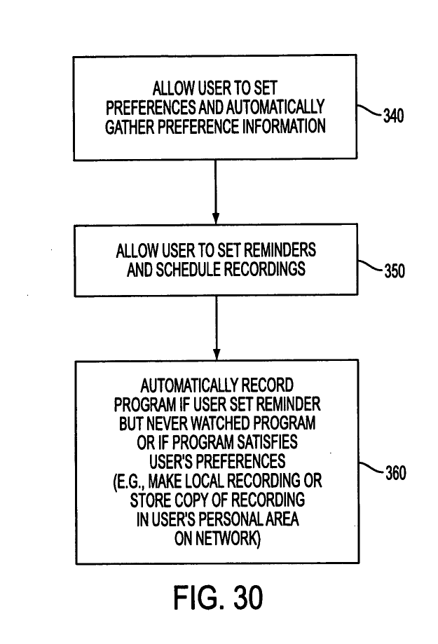

Illustrative steps involved in using the interactive television application to automatically record content with system 10 are shown in FIG. 30. At step 340, the interactive television application allows the user to set preferences manually (e.g., by interacting with on-screen preference options) and the interactive television application may also gather preference information by monitoring the user's actions (e.g., by monitoring the user's interactions with the interactive television application when watching certain television programming, ordering certain pay-per-view movies, selecting certain advertisements, recording certain content using the video-recorder capabilities of system 10, etc.).

At step 350, the interactive television application may be used to provide the user with opportunities to set program reminders and to schedule recordings (e.g., as described above in connection with FIGS. 12 and 22).

At step 360, the interactive television application may automatically record certain programs. For example, the interactive television application may automatically record a program if the user set a reminder for that program at step 350, but never watched that program. The interactive television application can determine when a program is or is not watched by monitoring whether the user equipment 18 is powered on and tuned to the appropriate channel during the time at which the program is scheduled to be broadcast or whether the user responds to the displayed reminder.

The interactive television application may also record programs at step 316 that the interactive television application determines satisfy the user's preferences. The interactive television application may use any suitable criteria to determine how restrictively or expansively to interpret the user's preferences.

Moreover, the user may be provided with an on-screen option or other interactive mechanism by which the user can adjust how many “hits” are produced when applying the user's preference profile or other preference criteria against the genre, actor, title, rating, critic's rating, and other information associated with a given program. The information used to label programs with various program attributes may be provided to the interactive television application from a data source such as data source 30 and stored in the program listings database (where it may be used to support criteria-based searching and sorting of program listings). This information may be used at step 360 when the interactive television application uses the user's preference information to determine which programs satisfy the user's preference and which do not.

The interactive television application may automatically record missed programs and programs satisfying the user's preferences locally on the user's equipment or on the network (e.g., using the network video-recorder capabilities of system 10 that are supported by equipment such as server 36, server 56, and equipment at service provider 50). If desired, automatic preference-based recording of a given program may only be performed when the user does not watch the given program.

The interactive television application screens that are provided by the interactive television application may, if desired, be displayed in a full-screen format. Alternatively, these screens (or portions of these screens) may be provided using a partial screen format. With a partial screen format, a partial screen may be displayed as an overlay on top of video content such as a video-on-demand video or a video recording that is being played back or a currently active television channel. Another suitable partial screen guide format that may be used involves reducing the size of the video somewhat so that the partial screen guide content may be displayed next to the video. With this arrangement, the display screen simultaneously contains both the partial screen guide content and the video, which is displayed in a reduced-size unobscured video window.

It is understood that the foregoing features, such as reminders, storing of programs, archiving of programs, and other associated features described above may used in conjunction with programs stored or archived on network-based or local personal video recorders. It is also understood that video recorders may include either or both network-based video recorders and local personal video recorders. These features may also be used for programs in systems wherein suitable combinations of network-based and local arrangements are implemented.

Thus, systems and methods for providing a user with a program guide interface using an interactive television application implemented on user equipment are provided in which status information regarding video-on-demand programs and recorded programs is provided to the user. One skilled in the art will appreciate that the present invention can be practiced by other than the described embodiments, which are presented for purposes of illustration and not of limitation, and the present invention is limited only by the claims which follow . . .

1. A method for providing a user with program information using an interactive television application implemented at least partially on user equipment, the method comprising:
displaying a list of program listings; and
allowing the user to scroll through the list backwards in time such that the displayed list includes at least one previously recorded program available for viewing by the user and at least one empty cell in the grid corresponding to an unrecorded program.

2. The method defined in claim 1, wherein the displayed list includes at least one video-on-demand program that is available for viewing by the user.

3. The method defined in claim 1, wherein at least one of the at least one previously recorded program is stored on a local personal video recorder.

4. The method defined in claim 1, wherein at least one of the at least one previously recorded program is stored on a network-based video recorder.

5. The method of claim 1 further comprising allowing the user to select for viewing a previously recorded program listed in the list.

6. The method of claim 1, wherein at least one program listed in the list is associated with a visual indicator, wherein the visual indicator indicates that the associated program is scheduled for recording.

7. The method of claim 1, wherein at least one program listed in the list is associated with a visual indicator, wherein the visual indicator indicates that the associated program has been recorded.

8. The method of claim 1, wherein at least one program listed in the list is associated with a visual indicator, wherein the visual indicator indicates that the associated program is currently being recorded.

9. The method of claim 1, wherein at least one program listed in the list is associated with a visual indicator, wherein the visual indicator indicates that the associated program is a video-on-demand program.

10. The method of claim 1, wherein the allowing the user to scroll the grid backwards in time comprises displaying a list of previously recorded programs.

11. The method of claim 1, wherein the list includes at least one video-on-demand program available for viewing.

12. The method of claim 1, wherein the allowing the user to scroll the list backwards in time comprises displaying at least one category of previously recorded programs.

13. The method of claim 1, wherein at least one program listed in the list is available for viewing for a limited time, the method further comprising allowing the user to extend the time of availability of said program.

14. The method of claim 1 further comprising allowing the user to set a reminder for at least one program listed in the list.

15. The method of claim 14 further comprising:
determining if the user is watching the program for which a reminder was set; and
recording automatically said program if the user is not watching said program.

16. The method of claim 1 further comprising allowing the user to schedule for recording at least one program listed in the list.

17. The method of claim 1 further comprising determining a personal profile based on gathered information relating to the user.

18. The method of claim 17 further comprising setting a reminder for a program, wherein said program is selected based at least in part on the personal profile.

19. The method of claim 17 further comprising recording a program, wherein said program is selected based at least in part on the personal profile.

20. The method of claim 1, wherein the allowing the user to scroll the list backwards in time comprises:
determining whether at least one row of the grid consists of empty cells; and
collapsing the grid to remove the at least one row of empty cells.

21. User equipment for providing a user with program information using an interactive television application implemented at least partially on user equipment, the user equipment comprising:
a display;
control circuitry configured to:
display a list of program listings; and
allow the user to scroll through the list backwards in time such that the displayed list includes at least one previously recorded program available for viewing by the user and at least one empty cell in the grid corresponding to an unrecorded program.

22. The user equipment of claim 21, wherein the displayed list includes at least one video-on-demand demand program that is available for viewing by the user.

23. The user equipment of claim 21, wherein at least one of the at least one previously recorded program is stored on a local personal video recorder.

24. The user equipment of claim 21, wherein at least one of the at least one previously recorded program is stored on a network-based video recorder.

25. The user equipment of claim 21, wherein the control circuitry is further configured to allow the user to select for viewing a previously recorded program listed in the list.

26. The user equipment of claim 21, wherein at least one program listed in the list is associated with a visual indicator, wherein the visual indicator indicates that the associated program is scheduled for recording.

27. The user equipment of claim 21, wherein at least one program listed in the list is associated with a visual indicator, wherein the visual indicator indicates that the associated program has been recorded.

28. The user equipment of claim 21, wherein at least one program listed in the list is associated with a visual indicator, wherein the visual indicator indicates that the associated program is currently being recorded.

29. The user equipment of claim 21, wherein at least one program listed in the list is associated with a visual indicator, wherein the visual indicator indicates that the associated program is a video-on-demand program.

30. The user equipment of claim 21, wherein the control circuitry, when configured to allow the user to scroll the grid backwards in time, is configured to display a list of previously recorded programs.

31. The user equipment of claim 21, wherein the list includes at least one video-on-demand program available for viewing.

32. The user equipment of claim 21, wherein the control circuitry, when configured to allow the user to scroll the grid backwards in time, is configured to display at least one category of previously recorded programs.

33. The user equipment of claim 21, wherein at least one program listed in the list is available for viewing for a limited time and the control circuitry is further configured to allow the user to extend the time of availability of said program.

34. The user equipment of claim 21, wherein the control circuitry is further configured to allow the user to set a reminder for at least one program listed in the list.

35. The user equipment of claim 34, wherein the control circuitry is further configured to:
determine if the user is watching the program for which a reminder was set; and
record automatically said program if the user is not watching said program.

36. The user equipment of claim 21, wherein the control circuitry is further configured to allow the user to schedule for recording at least one program listed in the list.

37. The user equipment of claim 21, wherein the control circuitry is further configured to determine a personal profile based on gathered information relating to the user.

38. The user equipment of claim 37, wherein the control circuitry is further configured to set a reminder for a program, wherein said program is selected based at least in part on the personal profile.

39. The user equipment of claim 37, wherein the control circuitry is further configured to record a program, wherein said program is selected based at least in part on the personal profile.

40. The user equipment of claim 21, wherein the control circuitry, when configured to allow the user to scroll the grid backwards in time, is configured to:
determine whether at least one row of the grid consists of empty cells; and
collapse the grid to remove the at least one row of empty cells.

41. A system for providing a user with program information using an interactive television application implemented at least partially on user equipment, the system comprising:
means for displaying a list of program listings; and
means for allowing the user to scroll through the list backwards in time such that the displayed list includes at least one previously recorded program available for viewing by the user and at least one empty cell in the grid corresponding to an unrecorded program.

42. The system of claim 41, wherein the displayed list includes at least one video-on-demand program that is available for viewing by the user.

43. The system of claim 41, wherein at least one of the at least one previously recorded program is stored on a local personal video recorder.

44. The system of claim 41, wherein at least one of the at least one previously recorded program is stored on a network-based video recorder.

45. The system of claim 41 further comprising means for allowing the user to select for viewing a previously recorded program listed in the list.

46. The system of claim 41, wherein at least one program listed in the list is associated with a visual indicator, wherein the visual indicator indicates that the associated program is scheduled for recording.

47. The system of claim 41, wherein at least one program listed in the list is associated with a visual indicator, wherein the visual indicator indicates that the associated program has been recorded.

48. The system of claim 41, wherein at least one program listed in the list is associated with a visual indicator, wherein the visual indicator indicates that the associated program is currently being recorded.

49. The system of claim 41, wherein at least one program listed in the list is associated with a visual indicator, wherein the visual indicator indicates that the associated program is a video-on-demand program.

50. The system of claim 41, wherein the means for allowing the user to scroll the grid backwards in time comprises means for displaying a list of previously recorded programs.

51. The system of claim 41, wherein the list includes at least one video-on-demand program available for viewing.

52. The system of claim 41, wherein the means for allowing the user to scroll the list backwards in time comprises means for displaying at least one category of previously recorded programs.

53. The system of claim 41, wherein at least one program listed in the list is available for viewing for a limited time, the system further comprising means for allowing the user to extend the time of availability of said program.

54. The system of claim 41 further comprising means for allowing the user to set a reminder for at least one program listed in the list.

55. The system of claim 54 further comprising:
means for determining if the user is watching the program for which a reminder was set; and
means for recording automatically said program if the user is not watching said program.

56. The system of claim 41 further comprising means for allowing the user to schedule for recording at least one program listed in the list.

57. The system of claim 41 further comprising means for determining a personal profile based on gathered information relating to the user.

58. The system of claim 57 further comprising means for setting a reminder for a program, wherein said program is selected based at least in part on the personal profile.

59. The system of claim 57 further comprising means for recording a program, wherein said program is selected based at least in part on the personal profile.

60. The system of claim 41, wherein the means for allowing the user to scroll the list backwards in time comprises:
means for determining whether at least one row of the grid consists of empty cells; and
means for collapsing the grid to remove the at least one row of empty cells.

61. Machine-readable media for use in an interactive television application implemented at least partially on user equipment, in which the interactive television application provides a user with program information, wherein the media is encoded with machine-readable instructions for performing the method comprising:
displaying a list of program listings; and
allowing the user to scroll through the list backwards in time such that the displayed list includes at least one previously recorded program available for viewing by the user and at least one empty cell in the grid corresponding to an unrecorded program.

62. The machine-readable media of claim 61, wherein the displayed list includes at least one video-on-demand program that is available for viewing by the user.

63. The machine-readable media of claim 61, wherein at least one of the at least one previously recorded program is stored on a local personal video recorder.

64. The machine-readable media of claim 61, wherein at least one of the at least one previously recorded program is stored on a network-based video recorder.

65. The machine-readable media of claim 61, wherein the method further comprises allowing the user to select for viewing a previously recorded program listed in the list.

66. The machine-readable media of claim 61, wherein at least one program listed in the list is associated with a visual indicator, wherein the visual indicator indicates that the associated program is scheduled for recording.

67. The machine-readable media of claim 61, wherein at least one program listed in the list is associated with a visual indicator, wherein the visual indicator indicates that the associated program has been recorded.

68. The machine-readable media of claim 61, wherein at least one program listed in the list is associated with a visual indicator, wherein the visual indicator indicates that the associated program is currently being recorded.

69. The machine-readable media of claim 61, wherein at least one program listed in the list is associated with a visual indicator, wherein the visual indicator indicates that the associated program is a video-on-demand program.

70. The machine-readable media of claim 61, wherein the allowing the user to scroll the grid backwards in time comprises displaying a list of previously recorded programs.

71. The machine-readable media of claim 61, wherein the list includes at least one video-on-demand program available for viewing.

72. The machine-readable media of claim 61, wherein the allowing the user to scroll the list backwards in time comprises displaying at least one category of previously recorded programs.

73. The machine-readable media of claim 61, wherein at least one program listed in the list is available for viewing for a limited time, wherein the method further comprises allowing the user to extend the time of availability of said program.

74. The machine-readable media of claim 61, wherein the method further comprises allowing the user to set a reminder for at least one program listed in the list.

75. The machine-readable media of claim 74, wherein the method further comprises:
determining if the user is watching the program for which a reminder was set; and
recording automatically said program if the user is not watching said program.

76. The machine-readable media of claim 61, wherein the method further comprises allowing the user to schedule for recording at least one program listed in the list.

77. The machine-readable media of claim 61, wherein the method further comprises determining a personal profile based on gathered information relating to the user.

78. The machine-readable media of claim 77, wherein the method further comprises setting a reminder for a program, wherein said program is selected based at least in part on the personal profile.

79. The machine-readable media of claim 77, wherein the method further comprises recording a program, wherein said program is selected based at least in part on the personal profile.

80. The machine-readable media of claim 61, wherein the allowing the user to scroll the grid backwards in time comprises:
determining whether at least one row of the grid consists of empty cells; and
collapsing the grid to remove the at least one row of empty cells.
